(19) United States
(12) Patent Application Publication
(10) Pub. No.: US 2023/0388959 A1
(43) Pub. Date: Nov. 30, 2023

(54) POSITIONING IN WIRELESS SYSTEMS

(71) Applicant: InterDigital Patent Holdings, Inc., Wilmington, DE (US)

(72) Inventors: Fumihiro Hasegawa, Westmount (CA); Moon-il Lee, Melville, NY (US); Tuong Duc Hoang, Montreal (CA); Jaya Rao, Montreal (CA); Paul Marinier, Brossard (CA)

(73) Assignee: InterDigital Patent Holdings, Inc., Wilmington, DE (US)

(21) Appl. No.: 18/031,767

(22) PCT Filed: Oct. 13, 2021
(86) PCT No.: PCT/US2021/054668

§ 371 Date: Apr. 13, 2023

Related U.S. Application Data
(60) Provisional application No. 63/091,005, filed on Oct. 13, 2020.
(60) Provisional application No. 63/136,436, filed on Jan. 12, 2021.
(60) Provisional application No. 63/185,729, filed on May 7, 2021.
(60) Provisional application No. 63/228,945, filed on Aug. 3, 2021.

(51) Int. Cl. H04W 64/00; G01S 13/76

(52) U.S. Cl. CPC H04W 64/00; G01S 13/765

(57) ABSTRACT

Systems, methods, and instrumentalities are disclosed herein associated with positioning in wireless systems. Features may be implemented, for example, in the behavior of a wireless transmit/receive unit (WTRU) for measurement reporting during a multi-beam channel scan, in WTRU behavior during a measurement report in the presence of a multipath, and/or in WTRU behavior during reporting to acquire correction information from the network. A WTRU may receive a PRS transmission via multiple paths, wherein the paths may be associated with the beams. The WTRU may report Rx−Tx time differences associated with the reception of the PRS transmission via multiple paths and transmission of respective SRSp's associated with the respective paths.

### CROSS-REFERENCE TO RELATED APPLICATIONS

This application claims the benefit of Provisional U.S. Patent Application No. 63/091,005, filed Oct. 13, 2020, Provisional U.S. Patent Application No. 63/136,436, filed Jan. 12, 2021, Provisional U.S. Patent Application No. 63/185,729, filed May 7, 2021, and Provisional U.S. Patent Application No. 63/228,945, filed Aug. 3, 2021, the disclosures of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

Systems, methods, and instrumentalities are disclosed herein associated with positioning in wireless systems. Features may be may be implemented, for example, in the behavior of a wireless transmit/receive unit (WTRU) for measurement reporting during a multi-beam channel scan, in WTRU behavior during a measurement report in the presence of a multipath, and/or in WTRU behavior during reporting to acquire correction information from the network.

A WTRU may receive a positioning reference signal (PRS) transmission via multiple paths. The WTRU may report Rx−Tx time differences associated with the reception of the PRS transmission via multiple paths and transmission of respective SRSp's associated with the respective paths. This may aid in the determination of an RTT.

A WTRU may receive information indicating resource(s) associated with a PRS transmission, where the PRS transmission may have an identifier. The information may comprise an indication to associate a respective PRS path ID with a respective SRSp resource. The WTRU may receive information indicating resource(s) associated with sounding reference signal for positioning (SRSp) transmission, where the SRSp transmission may have an identifier. The information may comprise respective spatial relation(s) for respective SRSp(s). The spatial relation may comprise a downlink (DL) reference signal (RS) that is associated with a receive (Rx) direction/beam.

A WTRU may receive a positioning reference signal (PRS) transmission via multiple paths. The respective path IDs may be assigned by the WTRU to respective paths if the WTRU receives the PRS transmission via multiple paths. For example, a first path may be assigned path ID 1 and a second path may be assigned path ID 2. The WTRU may associate the first path (e.g., assigned path ID 1) with a first SRSp (e.g., associated with SRSp identifier 2). The first path may be associated with a first SRSp based on a first path direction and a first SRSp spatial relation associated with the first path direction. The first SRSp spatial relation may be received from a network entity. The WTRU may associate the second path (e.g., assigned path ID 2) with a second SRSp (e.g., associated with SRSp identifier 1). The second path may be associated with a second SRSp based on a second path direction and a second SRSp spatial relation associated with the second path direction. The second SRSp spatial relation may be received from a network entity.

The WTRU may send an indication of the associations to a network entity (e.g., an LMF or gNB). The WTRU may transmit a first SRSp via a first SRSp resource (e.g., associated with SRSp identifier 1 which is associated with the second path assigned path ID 2) and may transmit a second SRSp via a second SRSp resource (e.g., associated with SRSp identifier 2 which is associated with the first path assigned path ID 1). The WTRU may determine a first receive to transmit (Rx−Tx) time difference associated with the first path. The first Rx−Tx time difference may be a time difference from a time when the PRS is received via the first path to a time when the first SRSp (e.g., associated with SRSp identifier 2) is transmitted. A second Rx−Tx time difference associated with the second path may be determined. The second Rx−Tx time difference may be a time difference from a time when the PRS is received via the second path to a time when the second SRSp (e.g., associated with SRSp identifier 1) is transmitted. An indication of the first and second Rx−Tx time differences may be sent to the network entity (e.g., an LMF or a gNB).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of multipath during positioning.

FIG. 3 illustrates an example for receiving standalone assisting information for a DL positioning method.

FIG. 4 illustrates an example of receiving standalone assisting information for a DL and UL positioning method.

FIG. 5 illustrates example values of WTRU reception-transmission (Rx−Tx) time differences.

FIG. 6 illustrates an example of a spatial relation configuration that may associate a PRS with an SRSp.

FIG. 7 illustrates an example of determining an Rx−Tx difference.

### DETAILED DESCRIPTION

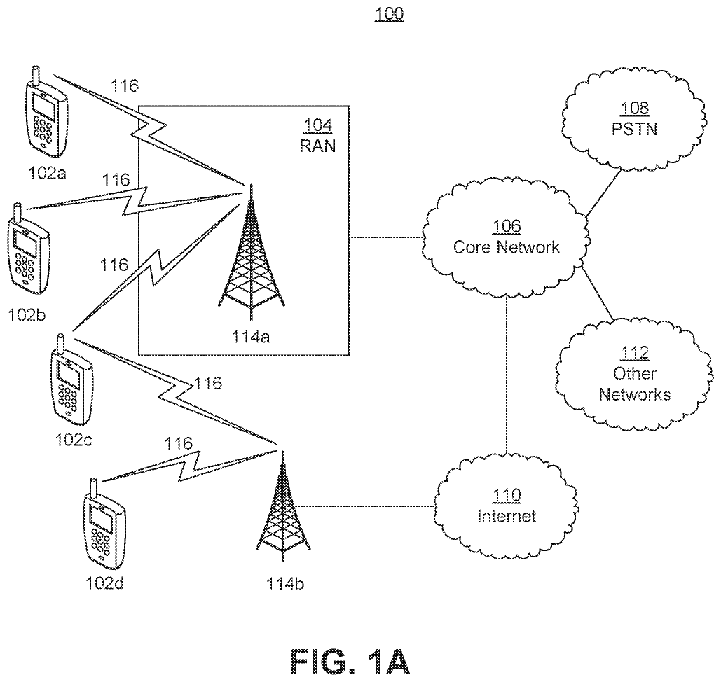

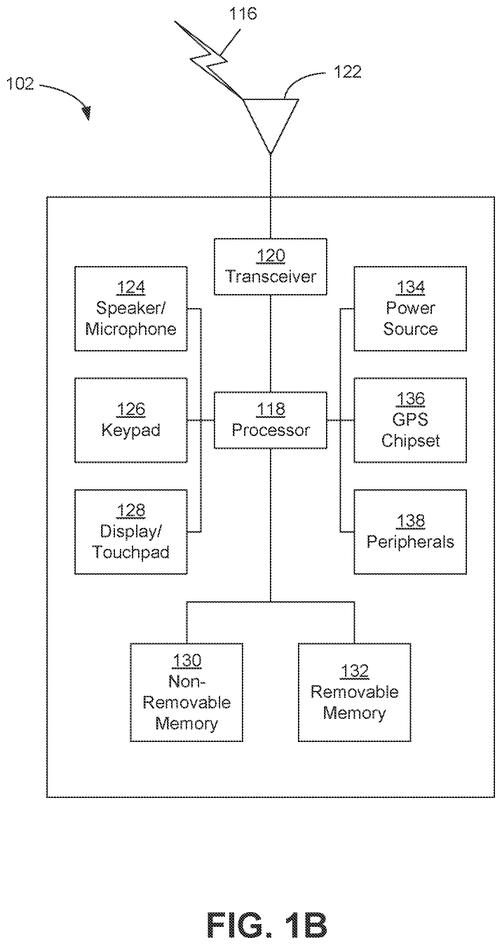

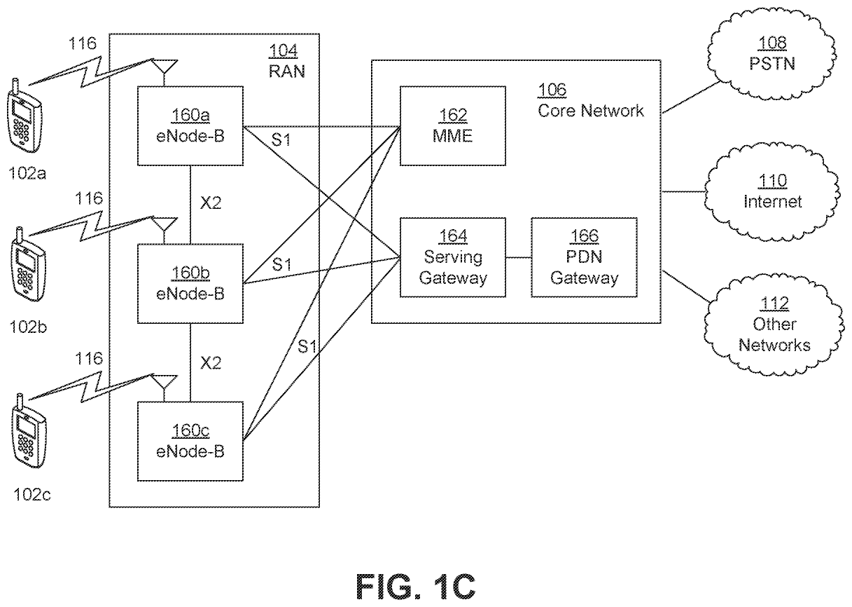

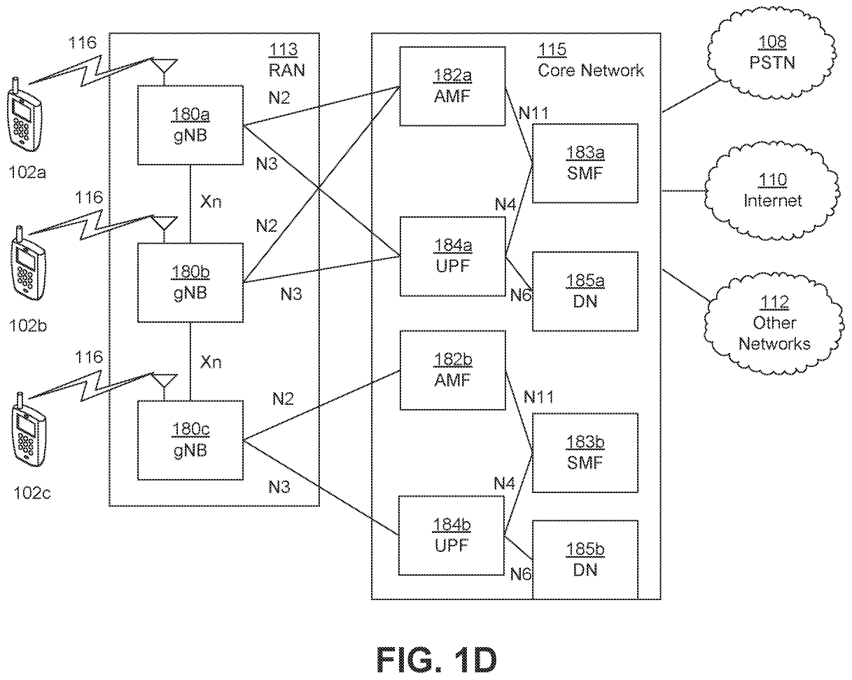

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (I) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (M IMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ M IMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The presence of a non-line of sight (NLOS) path in multipath (e.g., reception of a signal via multiple paths) may prevent a network from obtaining an accurate position of a WTRU, for example, due to multiple versions of received positioning reference signals (PRSs) that may arrive from different angles and/or at different time units (e.g., absolute time, symbol number, slot number, frame/subframe number, time offset with respect to a reference time, etc.). Accurate information for line of sight (LOS), NLOS, and/or other channel characteristics may support accurate positioning (e.g., positioning correction) determinations by a WTRU, server, etc. Beam refinement (e.g., at a WTRU or network) based on accurate information may generate assisting information to correct a positioning result for improved positioning accuracy (e.g., at low latency) in the presence of a multipath. Beam refinement may be driven by reports sent from or actions taken by a WTRU. LOS identification using uplink (UL) or downlink (DL) multi-beam may be supported, for example, for accurate positioning.

Behavior of a WTRU during gNB (e.g., network, base station, etc.) scanning of a channel may be provided. A WTRU may be configured (e.g., by higher layer, for example higher layer signaling) to report LOS. A WTRU may report (e.g., to a server) timing information of a configured downlink reference signal (DL RS) for positioning, for example, which may correspond to the largest reference signal received power (RSRP) among multiple configured reference beams. The network may conduct beam sweeping to find LOS and/or NLOS. The action may correspond to LOS-only reporting, for example, if multi-beam is configured. In examples, the WTRU may be configured by the network (e.g., LMF or gNB) to report LOS indicator(s) associated with one or more of the configured PRS resource(s), TRP IDs, or cell IDs. If the value of the LOS indicator associated with a PRS resource is 1, it may suggest that there is a high likelihood that the PRS on the PRS resource is received by the WTRU in a LOS path. If the value of the LOS indicator associated with a PRS resource is 0.8, it may suggest that there is a high likelihood, e.g., but lower likelihood than if the LOS indicator is 1, that the PRS on the PRS resource is received by the WTRU in a LOS path. If the value of the LOS indicator associated to a PRS resource is 0, it may suggest that there is a low likelihood that the PRS on the PRS resource is received by the WTRU in a LOS path. If the value of the NLOS indicator associated with a PRS resource is 1, it may suggest that there is a low likelihood that the PRS on the PRS resource is received by the WTRU in a NLOS path. In examples, it may be assumed that the WTRU is configured to report to the network LOS indicator(s) associated with PRS resource(s). The LOS indicator may be a value determined by the WTRU from a set of discrete values (e.g., [0, 0.5, 1], [0, 0.33, 0.66, 1], [0, 1], or [0.25, 0.5, 0.75, 1]). The LOS indicator may comprise a set of bits where a set (e.g., each set) may correspond to one of the discrete values (e.g., “00” for LOS indicator 0, “01” for LOS indicator 0.33, “10” for LOS indicator 0.66, and/or “11” for LOS indicator 1).

The WTRU may determine the LOS indicator based on measurements (e.g., time of arrival, angle of arrival, RSRP, RSTD, and/or WTRU Rx−Tx) made from PRSs on PRS resources and report the indicator(s) to the network. The WTRU may determine not to report the indicator, for example, if the WTRU cannot determine the likelihood of a path as LOS (e.g., the LOS indicator is 0.5 or the WTRU cannot determine or compute the indicator based on measurements made on received PRSs on PRS resources). In examples, the WTRU may determine to report an error value for the indicator if the WTRU cannot determine the value for the LOS indicator. For example, if the preconfigured set of discrete values for the LOS indicator is [0,1], the WTRU may not return the LOS indicator associated with the PRS resource to indicate to the network that the WTRU is not certain about the likelihood of LOS associated with the received PRS on the PRS resource. If the preconfigure set of discrete values for the LOS indicator is [0, 0.5, 1] and associated sets of bits for each discrete value is such that “00”, “01”, “10” and “11” are associated with the LOS indicator 0, 0.5, 1, “Error event or not available”, respectively, the WTRU may determine to report “11” to the network if the WTRU cannot determine the discrete value of the LOS indicator based on the measurements made on received PRS(s) on PRS resource(s).

A WTRU may recommend an association between a path (e.g., reception path, radio signals reaching the WTRU by two or more paths, LOS or NLOS path, etc.) in the multipath channel and beam information. For multipath, a channel as referred to herein may refer to a multipath channel. A WTRU may send a measurement report to the network. A report may include the association of a path ID (e.g., an additional path ID for an additional detected path) in the measured multipath, for example, with the channel state information reference signal (CSI-RS), PRS, and/or sounding reference signal (SRS) beams (e.g., SRS resource ID or SRS beam ID). The associated reference signal (RS) beam may be different from the RS beam the WTRU received that led to the discovery of multipaths. A WTRU based recommendation of multipath mitigation may consider different beamwidth and/or different granularity of transmission periods/offsets for UL and DL RS. The network may use a broad beam to scan a channel. A WTRU may transmit information. A WTRU may construct a report, for example, based on a spatial direction of the NLOS/LOS paths and/or relative delay of the LOS/NLOS paths.

A WTRU may alter or stop reporting. A WTRU may measure multiple paths. A WTRU may stop measurements of at least one of the configured PRS beams which may be associated with a PRS resource, for example, if the measured RSRP corresponding to the PRS beams is below a threshold and/or a variance of the RSRP is above the threshold. A measurement period of variance may be set (e.g., a period of time, which may be tracked for example by a timer) to collect an amount of information (e.g., enough information). Advice (e.g., implicit advice) may be provided for the network to discard measurements and/or to reduce the size of the measurement report, for example, which may result in a faster decision-making process.

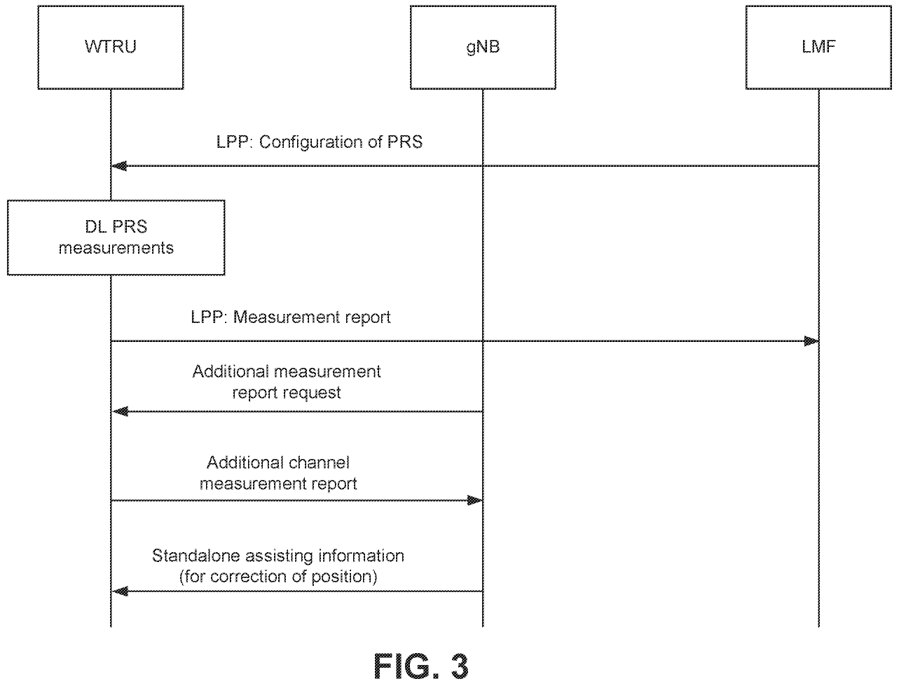

There may be coordination between DL and UL positioning. DL and UL positioning features are shown by example in FIG. 3. A WTRU may transmit multiple configured SRS beams for positioning. The WTRU may (e.g., be configured to) expect and/or receive a dynamic configuration of an SRS spatial relationship relating SRS for positioning (SRSp) and PRS and/or an indication of which direction the transmitted SRS was used (e.g., DL-UL coordination, no reporting, and/or beam sweeping).

Standalone assisting information for positioning correction may be generated, for example, at a function, which may be outside of a Location Management Function (LMF). Assisting information (e.g., additional assisting information) for positioning correction may include, for example, the information described herein and/or other information related to channels, such as a LOS/NLOS indication and/or measurement reports. The assisting information may be used, for example, to correct positioning results from positioning methods (e.g., as may be identified and/or defined herein). Assisting information may be delivered (e.g., delivered separately). Generation of the standalone assisting information may not depend on positioning (e.g., on LOS/NLOS detection). Assisting information may be generated in a function outside of LMF (e.g., in a RAN or within a WTRU for short latency). A WTRU may obtain standalone assisting information, for example, in an on-demand basis and/or a WTRU may be configured (e.g., by the server) to receive the standalone assisting information. Standalone assisting information for correction may be delivered by the WTRU to the function or may be delivered to the WTRU from the function for WTRU-based positioning. In examples, standalone assisting information may include, for example, multipath channel parameters (e.g., relative power offset, delay profile, etc.).

Positioning methods may include, for example, downlink, uplink, and downlink and uplink positioning methods. One or more transmission-reception points (TRPs) (e.g., multiple TRPs) may send one or more PRSs (e.g., multiple PRSs) to a WTRU, for example, in downlink positioning methods. A WTRU may observe multiple reference signals. The WTRU may measure a time difference of arrival between a pair of PRSs. The WTRU may report a measured reference signal time difference (RSTD) to the network (e.g., LMF which may be used as an example herein). The WTRU may return a measured reference signal received power (RSRP) for a PRS (e.g., each PRS). The LMF may determine (e.g., conduct) positioning of the WTRU, for example, based on the returned measurements. The WTRU may report an RSRP for one or more DL angle based positioning methods.

A WTRU may send an SRS for positioning to one or more reception points (RPs), for example, in uplink positioning methods. An SRS may be configured by a radio resource control (RRC). A TRP may, e.g., for timing-based methods, measure a relative time of arrival (RTOA) for a received SRS. The TRP may report measured values to an LMF. A WTRU may report an RSRP for an SRS. An RP may, e.g., for angle based uplink positioning methods measure an angle of arrival (AoA) and report the measured AoA to an LMF.

A WTRU may measure a receiver-transmitter (Rx−Tx) time difference between a received PRS and a transmitted SRS, for example, in an uplink and downlink positioning method. A WTRU may report an Rx−Tx time difference to an LMF. A WTRU may report a measured RSRP for a PRS. A TRP may compute an Rx−Tx difference between a received SRS and a transmitted PRS.

Timing information may be a component in positioning. Timing issues (e.g., and positioning issues) may arise. For example, DL and/or uplink UL reference signals (RSs) for positioning that go through multipaths may generate multiple copies at the receiver side, for example, which may create multiple timing measurements and/or angle measurements at a receiver. A multipath may be a combination of LOS and NLOS paths. Identification of LOS and NLOS paths in a multipath may be useful, for example, to determine accurate timing and positioning.

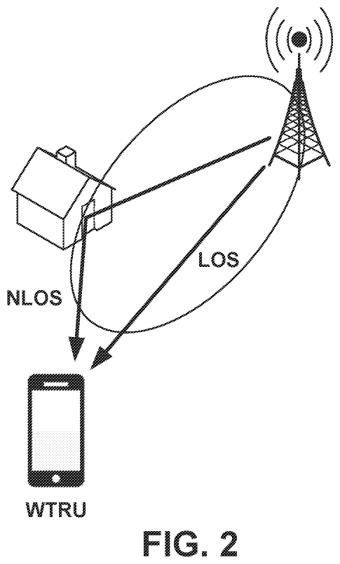

FIG. 2 illustrates an example of multipath during positioning.

A WTRU may report information related to paths (e.g., additional paths) that the WTRU may observe, for example, if the WTRU receives a PRS from a TRP.

Positioning accuracy may be degraded without a mechanism to identify paths (e.g., as LOS or NLOS). A WTRU may measure multipath information. Positioning accuracy may be supported, for example, by permitting/allowing a WTRU to associate path information with a DL RS and/or a UL RS.

A multiple beam and report configuration may be provided (e.g., and/or utilized), for example, for positioning. “SRS for positioning” may refer to an SRS signal/transmission used for positioning. Resources for an SRS for positioning may be defined/configured (e.g., signaled), e.g., by an RRC. An “SRS for positioning” or “SRS” may include, for example, at least one of the following: an SRS configured under SRS-PosResourceSet-r16 and SRS-PosResource-r16; an SRS configured under SRS-ResourceSet and SRS-Resource; an SRS not configured under SRS-PosResourceSet-r16 and SRS-PosResource-r16; an SRS not configured under SRS-ResourceSet and SRS-Resource; an SRS not associated with SRS-PosResourceSet-r16, SRS-PosResource-r16, SRS-ResourceSet or SRS-Resource; an uplink reference signal associated with positioning; a demodulation reference signal (DM-RS) for uplink; or a phase tracking reference signal (PTRS) for uplink.

SRS for positioning may be denoted as “SRSp.” PRS and SRS may not be limited to an RS used for positioning. Examples described herein may be applied to or used with DL reference signals (e.g., any DL reference signals) and UL reference signals (e.g., any UL reference signals).

Examples described herein may be applicable to one or more of the following positioning methods: a “DL positioning method,” a “UL positioning method,” or a “DL and UL positioning method.” The methods may be implemented in devices such as WTRU(s), device(s) on the network side, etc.

A “DL positioning method” may refer to positioning methods that utilize a downlink reference signal (e.g., a PRS). A WTRU may receive multiple reference signals from a TP. A WTRU may measure a DL RSTD and/or RSRP. DL positioning methods may include, for example, downlink angle of departure (DL-AoD) positioning, downlink time difference of arrival (DL-TDOA) positioning, etc.

An “UL positioning method” may refer to positioning methods that utilize uplink reference signals (e.g., an SRS) for positioning or SRS measurements. A WTRU may transmit an SRS to multiple RPs (e.g., a network device which receives SRS from the WTRU). The RPs may measure the UL RTOA and/or RSRP. UL positioning methods may include, for example, UL-TDOA positioning, UL-AoA positioning, etc.

RP, TP, and TRP may refer to a network device. In examples, RP, TP, and TRP may refer to whether the “Point” transmits (e.g., only transmits), for example, which may be referred to as a TP; receives (e.g., only receives), for example, which may be referred to as an RP; or transmits and receives (e.g., both transmits and receives), for example, may be referred to as a TRP. For UL positioning methods (e.g., UL TDOA or UL-AoA), the network side devices may be referred to as RP (e.g., the network only receives SRS from the WTRU). For DL positioning methods, the network devices may be referred to as TRP or TP (e.g., network either only transmits PRS or transmits PRS and receives measurements). For DL and UL positioning methods (e.g., mult-RTT), the network devices may be referred to as TRP (e.g., network transmits PRS and receives SRS).

A “DL and UL positioning method” may refer to positioning methods that utilize uplink and downlink reference signals for positioning. In examples, a WTRU may transmit an SRS to multiple TRPs and a network (e.g., a base station or gNB) may measure an Rx−Tx time difference. The network may measure RSRP for the received SRS. The WTRU may measure an Rx−Tx time difference for a PRS transmitted from multiple TRPs. The WTRU may measure RSRP for the received PRS. The Rx−TX difference and/or RSRP measured at the WTRU and/or the network may be used to compute a round trip time (RTT). A WTRU Rx and Tx difference may refer to the difference between an arrival time of the reference signal transmitted by the TRP and a transmission time of the reference signal transmitted from/by the WTRU. A network (e.g., gNB) Rx and Tx difference may refer to the difference between an arrival time of the reference signal transmitted by the WTRU and a transmission time of the reference signal transmitted from/by the network (e.g., a gNB or TRP). Multi-RTT positioning may be an example of DL and UL positioning.

A network may include, for example, one or more of the following: an access and mobility management function (AMF), an LMF, a next generation RAN (NG-RAN), etc.

An LMF may be an example of a node or entity (e.g., network node or entity) that may be used for or to support positioning. Other types of nodes or entities may be substituted for the LMF and may be applicable with this disclosure.

“Location information” and “location estimate” may be used interchangeably herein. “Transmission of a PRS resource” and “transmission of PRS on a PRS resources” may be used interchangeably herein. “Reception of a PRS resource” and “reception of PRS on a PRS resource” may be used interchangeably herein. “Transmission of a SRS resource” and “transmission of SRS on a SRS resource” may be used interchangeably herein. “Reception of an SRS resource” and “reception of SRS on a SRS resource” may be used interchangeably herein. “Transmission of an SRSp resource” and “transmission of SRS on a SRS resource” may be used interchangeably herein. “Reception of a SRSs resource” and “reception of SRSs on a SRSs resource” may be used interchangeably herein.

Multi-beam based positioning may be provided (e.g., configured and/or utilized). Multi-beam diversity may be provided for positioning measurements. A positioning measurement reference signal (PMRS) may be transmitted or received in one or more beams. A beam may include (e.g., be referred to as), for example, a quasi co-location (QCL) type-D, spatial relation information, a beam reference signal, a channel state information reference signal (CSI-RS) index, and/or a synchronization signal block (SSB) index. PMRS may be used interchangeably, for example, with PRS, SRSp, global navigation satellite signal (GNSS) signal, beam reference signal for positioning, CSI-RS, and/or SSB.

One or more beams may be used for a PMRS transmission. The one or more beams may be transmitted, for example, from a TRP or cell (e.g., the same TRP or cell). The one or more beams may be transmitted, for example, using spatial division multiplexing (SDM), time division multiplexing (TDM), and/or frequency division multiplexing (FDM). A set of beams used for a PMRS transmission (e.g., from the same TRP or cell) may be referred to as a positioning beam group (PBG).

A WTRU may be configured with a PBG for positioning measurement reporting. A WTRU may perform a positioning measurement from the PBG, for example, based on at least one of following.

A WTRU may report a positioning measurement of beams (e.g., all beams) in a PGB with one or more multi-paths (e.g., first N paths) for a beam (e.g., each beam) in the PBG. The value of N may be determined, for example, based on the number of beams in the PBG. The value of N may be equal to three, for example, if the number of beams in PBG (e.g., M) is less than a threshold (e.g., M<2) and N may be equal to one (1), for example, if otherwise (e.g., M≥2). The value of N may be configured or determined per beam (e.g., beam index).

A WTRU may report a positioning measurement of a subset of beams in a PBG with one or more multi-paths (e.g., first N paths) for the subset of beams. A subset of beams may be determined, for example, based on at least one of following: a beam with an LoS path, a beam with the strongest RSRP for the first path, a beam with the smallest number of paths, or a beam with the highest measurement accuracy and/or quality. A subset of beams may include one or more beams (e.g., a single beam or multiple beams).

A WTRU may report a positioning measurement of one or more beams, for example, if the one or more beams meet (e.g., satisfy) one or more conditions (e.g., predefined conditions). Condition(s) may include, for example, at least one of following: whether an LoS path is present for a beam, whether a positioning measurement quality (e.g., an RSRP or a level one (L1)-RSRP) is higher than a threshold, or whether the number of paths in a multi-path channel is smaller than a threshold.

One or more of modes of operation may be used (e.g., single beam mode or multi-beam mode). A first mode of operation may be a single beam operation for positioning (SBP) and a second mode of operation may be a multi-beam operation for positioning (MBP). For example, an SBP may be based on a PBG with a single beam. A PBG that includes a single beam for a positioning measurement may be referred to as an SBP. For example, an MBP may be based on a PBG with more than one beam. A PBG that includes more than one beam for a positioning measurement may be referred to as an MBP.

A WTRU may determine a mode of operation (e.g., SBP or MBP) for a positioning measurement, for example, based on one or more of following.

A mode of operation may be configured, for example, for one or more sources (e.g., all sources or each source). A source may be, for example, a TRP, a cell, etc.

A mode of operation may be indicated, for example, based on an aperiodic positioning measurement (e.g., a mode may be indicated if aperiodic positioning measurement reporting is triggered). For example, a triggering downlink control information (DCI) may indicate the mode of operation. A mode of operation may be determined (e.g., implicitly determined), for example, based on the number of beams in a PBG, which may be indicated in a triggering DCI.

A mode of operation may be determined, for example, based on a channel condition. For example, a WTRU may be configured with SBP and MBP. A WTRU (e.g., configured with SBP and MBP) may determine a first mode of operation (e.g., MBP), for example, if one or more of conditions are met (e.g., satisfied) and may determine a second mode of operation (e.g., SBP), for example, otherwise (e.g., if the conditions are not met). A WTRU may determine a first mode of operation (e.g., MBP), for example, if one or more of the following conditions are met (e.g., and the WTRU may determine a second mode of operation, such as SBP, if the following conditions are not met): a measurement quality (e.g., and/or a beam quality) of one or more beams (e.g., all beams and/or the strongest beam) in an MBP is lower than a threshold, an RSRP gap between the strongest beam and the second strongest beam is larger than a threshold in the PBG, an LoS path exists for the positioning measurement in an SBP, or a measurement quality (e.g., and/or a beam quality) of the beam in an SBP is higher than a threshold.

A mode of operation may be indicated, for example, in a DCI triggering aperiodic positioning measurement reporting.

Features associated with reporting behavior may be provided. Reporting may stop, for example, if an RSRP or a variance of an RSRP of a measurement is below a threshold. A WTRU may perform periodic reporting of a positioning measurement. A WTRU may be configured with one or more sets (e.g., multiple sets) of reporting resources to perform positioning measurement reporting. A set (e.g., each set) of reporting resources may include, for example, at least one of the following: the time and frequency of the resource for reporting, the time offset of the resource, or the periodicity of the resource.

A WTRU may be configured with which beam and/or which path of a beam (e.g., each beam) to report (e.g., for each set of reporting resources). In examples, a WTRU may be configured multiple sets (e.g., two) of reporting resources. A WTRU may be configured with a first set of reporting resources that may be used to report the first path and/or the strongest path of the beams (e.g., all beams). A WTRU may be configured with a second set of reporting resources that may be used to report the second path and/or the second strongest path of the beams (e.g., all beams). The first set of reporting resources may have shorter periodicity than the second set of reporting resources, for example, which may allow/permit a WTRU to less frequently report (e.g., occasionally report) the second path and/or the second strongest path of each beam (e.g., compared to more frequent reports of the first path and/or the strongest path). In examples, a WTRU may be configured with multiple sets of reporting resources, in which a set (e.g., each set) of reporting resources may be associated with the measurement of a beam (e.g., one beam).

A WTRU may determine which beam/path to report, for example, if performing positioning measurement reporting. A WTRU may determine which beam/path to report on in positioning measurement reporting. A WTRU may be configured with, for example, one or more of the following parameters (e.g., to determine whether to report a beam, a path, and/or an RSTD for a positioning measurement): the minimum RSRP and/or received signal strength indicator (RSSI) of the beam; the minimum RTT gap between the considered beam and the smallest RTT; the minimum RSRP/RSSI of the path to report; the minimum and/or maximum time gap (e.g., delay spread) between two paths; the minimum and/or maximum RSTD difference between the considered beam and the smallest RSTD of one or more other TRP pairs; or the minimum variance of RSRP of the beam.

A WTRU may determine whether to report a beam, a path, and/or the RSTD for a positioning measurement based on, for example, the minimum RSRP/RSSI of the beam. A WTRU may report the positioning measurement of a beam, for example, if the RSRP/RSSI of the beam is greater than the configured minimum value.

A WTRU may determine whether to report a beam, a path, and/or an RSTD for a positioning measurement based on, for example, the minimum RTT gap between the considered beam and the smallest RTT. For example, a WTRU may be configured to report the positioning measurement of multiple beams (e.g., two beams). The WTRU may (e.g., be configured to) not report the positioning measurement of one of the beams, for example, if the time gap difference between multiple RTTs (e.g., two RTTs) is larger than a configured value.

A WTRU may determine whether to report a beam, a path, and/or an RSTD for a positioning measurement based on, for example, the minimum RSRP/RSSI of the path to report. A WTRU may report a positioning measurement of a path, for example, if the RSRP/RSSI of the path is greater than the configured minimum value.

A WTRU may determine whether to report a beam, a path, and/or an RSTD for a positioning measurement based on, for example, the minimum and/or maximum time gap (e.g., delay spread) between two paths.

A WTRU may determine whether to report a beam, a path, and/or an RSTD for a positioning measurement based on, for example, the minimum and/or maximum RSTD difference between the considered beam and the smallest RSTD of one or more TRP pairs (e.g., other TRP pairs).

A WTRU may determine whether to report a beam, a path, and/or an RSTD for a positioning measurement based on, for example, the minimum variance of RSRP of the beam. The presence of LOS may be indicated, for example, by a low variance in RSRP. The presence of NLOS may be indicated, for example, by a high variance in RSRP. A WTRU may determine not to perform measurements, for example, for a path that exhibits an RSRP variance below a threshold.

A WTRU may determine whether to report a positioning measurement of a beam/path, for example, based on a change compared to reporting (e.g., previous reporting). A WTRU may determine whether to report a positioning measurement of a beam/path (e.g., one beam/path), for example, based on a variance of the positioning measurement compared to a previous reported positioning measurement (e.g., the last reported positioning measurement). A WTRU may not perform positioning measurement reporting of one or more of a beam/path, RSTD, etc., for example, if the variance of the measurement compared to a previously reported measurement is smaller (e.g., less) than a threshold. In examples, a WTRU may be configured with an RSRP variance threshold, for example, to determine whether to perform reporting of a beam. The WTRU may report the positioning measurement of the beam, for example, if the RSRP difference between the current measurement and the last reported measurement is greater than a threshold. The WTRU may not perform reporting of a positioning measurement of the beam, for example, if the RSRP difference between the current measurement and the last reported measurement is equal to or less than the threshold.

The size of a report may be reduced, the frequency of a report may be reduced, and/or the system may achieve accurate positioning at low latency, for example, by applying multi-beam based positioning and/or reporting behavior (e.g., as described herein).

Path information may be associated with reference signals. For example, a WTRU may identify multipath paths and may make respective associations (e.g., connections) between a respective path and a respective reference ID, for example, a respective reference ID number. A reference ID may be one or more of the following: PRS resource ID number, SRS for positioning resource ID number, SRS resource ID number, PRS resource set ID number, SRS for positioning resource set ID number, or SRS resource set ID number.

A WTRU may (e.g., in the presence of the multipath channels) detect multiple paths, for example, by receiving multiple copies of a transmitted PRS from a TP. A different RSRP, ToA, and/or RSTD may be observed for the received PRS. The size of a report may increase and/or the quality of the report may be degraded, for example, if the WTRU reports timing related information and RSRP. Positioning/location information may be associated with short latency. Reporting may consume time for preparation, for example, which may increase latency (e.g., and may lead to a large latency). Bandwidth efficient reporting may be achieved without a large latency, for example, if a WTRU can (e.g., is configured to) associate one or more beams (e.g., preconfigured) with a detected path and report the association(s) to the network.

A WTRU may report an association between detected paths and reference signals to a network, for example, to assist the network with identification of NLOS and LOS paths. In examples, a WTRU may be configured with PRS resources. A resource (e.g., each resource) may be associated with a beam transmitted from a TP. A WTRU may receive a PRS (e.g., a PRS transmission) from a TP and may detect multiple paths. A WTRU may determine whether to assign an identification number to a detected path, for example, if at least one of the following criteria is satisfied: an RSRP measured for the detected path is above a threshold (e.g., predefined threshold), or a difference in a ToA compared to one or more other detected paths is above the threshold (e.g., predefined threshold).

A WTRU may (e.g., determine to) assign an identification number to a detected path, for example, if the above criteria and/or conditions are not satisfied. An identification number assigned to a detected path may be referred to as a “path ID.”

A WTRU may report detected paths and/or a respective path ID associated with each respective detected path to the network, for example, if the WTRU receives a request from the network to send the assignment (e.g., an assignment of a path identifier (ID) to a detected path). In examples, the WTRU may detect 4 paths in the multipath channel and the WTRU may assign path ID #1, #2, #3 and #4 to each detected path and may report the assignment to the network. In examples, the order of assignment may be based on RSRP (e.g., the path with highest RSRP may receive ID #1 and the path with the lowest RSRP may receive the last ID number) or time of arrival (e.g., the first path with the earliest time of arrival may receive ID #1 and the path with the latest time of arrival may receive the last ID number). The WTRU may assign ID #1 to the LOS path and rest of ID numbers to NLOS paths based on the criteria using RSRP or time of arrival. The WTRU may use a protocol (e.g., LIE positioning protocol (LPP) or RRC signaling) to send the assignment. A WTRU may, e.g., if configured by the network, send an assignment by uplink control information (UCI) or a MAC control element (MAC-CE). A WTRU may send a report, for example, using RRC signaling, MAC-CE, or UCI. A WTRU may include a report in a physical uplink control channel (PUCCH) transmission or a physical uplink shared channel (PUSCH) transmission.

A WTRU may associate a path (e.g., first path or a second path which may include a first path ID or a second path ID, respectively) with one or more configured reference signals (e.g., a first configured reference signal or a second configured reference signal). A reference signal may be associated with an identification number assigned to the detected paths. A reference signal may include, for example, at least one of the following: a CSI-RS, a PRS, a DM-RS, a tracking reference signal (TRS), a DL PTRS, a UL PTRS, an SRSp, or an SRS.

A WTRU may associate a path ID with a reference signal, for example, by using the resource ID or other ID (e.g., unique ID), such as an ID that may be used to generate the reference signals, A WTRU may associate a path ID with a resource set ID, e.g., if available, that may be assigned to the reference signal.

In examples, e.g., with reference to the example(s) as described with respect FIG. 2, a WTRU may report to the network (e.g., a network entity such as an LMF or a gNB), for example, that a path (e.g., ID #1), which corresponds to the NLOS path in FIG. 2, is associated with SRS resource #2, which belongs to SRS resource set #1. As described herein, different resource numbers may correspond to transmission beams aimed in different directions. A WTRU may inform the network about the direction corresponding to where the path was detected, for example, by associating the path ID with the resource ID. The network may have knowledge about the direction a FRS is transmitted and the direction of the SRS transmission beam corresponding to SRS resource #2. The association of a resource and a path ID may assist the network with a direction in which the WTRU may have received the PRS, which may support (e.g., lead to) identification of an NLOS path.

A WTRU may, e.g., if requested by the network, report an association between a path ID and an RS to the network. A WTRU may include (e.g. in a report), for example, timing related information, an RSRP, and/or association information. A WTRU may send the report using, for example, RRC, MAG-CE, or UCI. A WTRU may include the report, for example, in a PDCCH transmission or a PDSCH transmission.

A WTRU may receive spatial information from the network (e.g., from an LMF or gNB) that associates a DL RS transmitted from a TRP, a UL RS, and/or a path ID. For example, the WTRU may receive PRS resource #1 associated with a path (e.g., path ID #0) and SRS resource ID #2 (e.g., based on spatial information such as path direction and spatial relation). The WTRU may receive spatial information from the network that associates multiple DL RS's with the same path ID, for example, which may indicate that the multiple DL RS(s) may be transmitted from a TRP and may reach the WTRU along a same path indicated by the path ID. The WTRU may receive information (e.g., configuration information) that associates multiple UL reference signals with the same path ID, for example, which may indicate that the multiple UL reference signals may reach the TRP along a same path indicated by path ID.

In examples, LOS and NLOS path detection may be implemented (e.g., as described herein) without large bandwidth to send a measurement report (e.g., detailed measurement report).

There may be coordination between downlink and uplink. In examples of a DL and UL positioning method, a TRP (e.g., each TRP) may send a PRS to the WTRU and the WTRU may send an SRSp (e.g., in return) to the TRP (e.g., each TRP). An Rx−Tx time difference may be computed at the TRP (e.g., each TRP) and WTRU. The WTRU may receive the transmitted PRS from the TRP. The WTRU may receive multiple copies of the PRS, for example, due to the presence of multipath. A bandwidth efficient reporting method may assist the network with detection of LOS and/or NLOS paths.

A WTRU may determine the direction of LOS and/or NLOS paths from the dynamic association between DL and UL reference signals generated by the network.

A WTRU may conduct beam sweeping, for example, using an SRSp. Beam sweeping may be configured, for example, by setting periodicit(ies) of transmissions of SRSp. A WTRU may, for example, transmit a different beam at each transmission occasion (e.g., switch beams for each transmission occasion). A WTRU may repeat transmission of a beam (e.g., the same beam at a predefined number of repetitions) during periodic transmission of an SRSp.

A beam (e.g., each beam) transmitted from the WTRU may be assigned a corresponding SRSp resource identification number. An SRSp may be used to conduct beam sweeping. A WTRU may receive an association report from the network, for example, which may associate an SRSp (e.g., each SRSp) with a DL reference signal with an identification number. An identification number (e.g., a resource ID or resource set ID) may be aligned with the Rx beam used by the TRP to receive the transmitted SRSp. An association report may be a reconfiguration of a spatial relationship between SRSp and DL reference signals. The network may associate a received SRSp with another SRSp with a different identification number, which may occur, for example, if the received SRSp goes through the LOS path. A different SRSp beam may have gone through the same LOS path.

A WTRU may receive an association between SRSp and DL reference signals or UL reference signals, for example, via DCI, MAC-CE, or RRC. For example, a WTRU may determine the change in spatial relation information for SRSp by DCI, DL reference signals may include, for example, one or more of the following: a CSI-RS, a DMRS, a FRS, a TRS, or a FIRS: A WTRU may receive a configuration associating a transmitted SRSp with an SSB.

A WTRU may use beams that are associated with a DL RS, for example, if the WTRU receives an update for the spatial relationship information. A WTRU may, e.g., if the WTRU receives an update for the spatial relationship information, perform another beam sweep focusing, for example, on beams that may be within the same direction as beams that are associated with the DL RS in the updated spatial information. In examples, the WTRU may receive spatial information relating SRSp resource #1 to #4 with PRS resource #1. In the updated spatial information, the WTRU may receive spatial information relating SRSp resources #3 to #6 with PRS resource #1. In this case, based on updated spatial information, the WTRU may perform beam sweeping using SRSp resources #3 to #6 which are related to PRS resource #1.

LOS and NLOS path detection may be implemented (e.g., as described herein) without a large bandwidth to send measurement reports (e.g., detailed measurement reports), allowing the system to perform positioning (e.g., accurate positioning).

A WTRU may determine and/or report its orientation. The WTRU may report information related to its orientation angle to a network. The network may configure PRS transmission parameters in the presence of multipaths, for example, based on the WTRU's orientation angle. For example, the likelihood that LOS may be present may depend on the orientation of the WTRU and that information may be used by the network to configure a PRS (e.g., so that the accuracy of positioning may be improved). “WTRU orientation,” “WTRU orientation angle,” “orientation angle,” and “orientation information” may be used interchangeably herein.

A WTRU may report absolute or relative WTRU orientation, for example, explicitly. The WTRU may report its orientation to the network, for example, to assist the network with reconfiguring parameters of the network and/or the WTRU. The WTRU may indicate (e.g., explicitly indicate) its orientation information to the network, for example, in a measurement report. In examples, the orientation of the WTRU may be defined as the direction that a reference point of the WTRU is facing. The reference point may be implementation dependent. For example, the reference point may be a screen of a smartphone. Information related to the orientation angle of a WTRU may include at least one of the following: an Azimuth angle, where the angle may be measured counter-clockwise from the geographical North and/or counter-clockwise from the x-axis of a local coordinate system (LCS), an elevation angle that may be measured relative to zenith and pointing to the horizontal direction, or an elevation angle that may be measured relative to the z-axis of an LCS.

A WTRU may report a rotation angle with respect to a reported orientation value (e.g., previously reported orientation value). For example, the WTRU may report angles measured counter-clockwise from the previously reported WTRU orientation. The occasion to report the rotation angle of the WTRU may include a measurement reporting occasion. For example, the WTRU may report the rotation angle with respect to the orientation of the WTRU at the last measurement reporting occasion.

A WTRU may be (pre)configured to report the orientation angle of the WTRU based on the RSRP for a received PRS from a TRP falling below a preconfigured threshold and/or based on the RSRP of a received PRS from a TRP remaining below a preconfigured threshold, for example, during a preconfigured duration.

A WTRU may include information related to the WTRU's orientation in a request for configuration or reconfiguration of PRS related parameters (e.g., in LPP request assistance data). The request for the configuration or reconfiguration of PRS related parameters may include one or more of the following: the number of symbols for PRS, the transmission power for a PRS, the number of PRS resources included in a PRS resource set, a muting pattern of a PRS (e.g., the muting pattern may be expressed in bitmap), the periodicity for a PRS, the type of PRS or SRS (e.g., periodic, semi-persistent, or aperiodic), a slot offset for periodic transmission of PRS, a vertical shift of a PRS in the frequency domain, a time gap during the repetition of a PRS, a repetition factor for a PRS, an RE offset for a PRS, a combination pattern for a PRS, a spatial relation, a sequence ID used to generate a PRS or PRS ID, a TRP ID, or the like.

WTRU orientation information may be transmitted via an LPP message or RRC message, for example, to an LMF or RAN. A WTRU may send information related to WTRU orientation, for example, if the WTRU sends capability information about the WTRU to the network. The request for reconfiguration may include at least one of a request to transmit a PRS from different TRP(s) or a request for new PRS resource(s), PRS resource ID(s) or PRS resource set(s).

A WTRU may report its orientation information, for example, implicitly. The WTRU may send information that may be used to infer the WTRU's orientation. For example, the WTRU may report a panel ID, a receive beam group index, or a receive beam set index to which a DL-PRS receive beam index belongs (e.g., along with the DL-PRS receive beam index). The WTRU may report the panel ID from which an SRS for positioning may be transmitted. The panel ID may correspond to the panel used to receive a DL-PRS and/or to transmit an SRS for positioning. The WTRU may report a different panel ID from the panel ID configured by the RAN or LMF to transmit an SRS for positioning (e.g., the WTRU may report its orientation implicitly using feature(s) described herein).

A WTRU may have an Rx antenna gain for a panel (e.g., a different Rx antenna gain for each panel). The WTRU may send (e.g., indicate) the gain characteristics of an Rx beam or Rx panel, for example, as part of the WTRU capability information. The capability information may assist the network with inferring the orientation of the WTRU, for example, based on reported RSRP characteristics. Gain characteristics of Rx beams may be represented by relative difference in gains among RX beams. Panel information associated with different gains may assist the network with computing the orientation angle of the WTRU.

The information described herein may be used by the network to determine the orientation of the WTRU, for example, if knowledge of the location(s) of the relevant panels is available to the network.

A WTRU may request a reconfiguration of PRS related parameters, for example, if one or more characteristics of an Rx beam change over a preconfigured threshold. The changes may include, for example, a change of an Rx beam index over a preconfigured duration and/or a change of an Rx panel or resource set index over a preconfigured duration.

An index associated with the highest RSRP measurement may be indicated. The index that a WTRU is to report may be (pre)configured. For example, the WTRU may indicate, e.g., to the network, a beam index, a panel index, a beam group index, and/or a beam set index at which the highest RSRP is measured for a PRS resource (e.g., given PRS resource) in a resource set. The measured RSRP may be the highest among measured RSRP using one or more Rx beam indices (e.g., all Rx beam indices) for a PRS resource (e.g., given PRS resource) or the WTRU may report the highest RSRP along with a group or set of one or more PRS beam indices, resource indices, and/or resource set indices. For example, the WTRU may report, for a given PRS resource set, the PRS resource ID that may yield the highest RSRP along with the measured RSRP. The WTRU may report the PRS resource set that may yield the highest RSRP among configured PRS resources sets. The WTRU may (e.g., for a given PRS resource set) report the pair of Rx beam indices, Rx panel IDs, and/or PRS resource IDs that may correspond to the highest RSRP. The WTRU may include an indicator in the report to indicate that the reported index or indices correspond to the PRS resource/resource set index, Rx beam index/panel ID, or the pair of Rx beam indices and/or PRS resource IDs that may yield the highest RSRP.

The indication may be included in an LPP message, an RRC message, DCI, or MAC-CE. The index at which the highest RSRP is obtained may be used to infer the direction that the WTRU may be facing (e.g., which may assist the network with determining the WTRU's orientation angle). The WTRU may include an indication (e.g., in the same message) that the measured RSRP is the highest.

A WTRU may report or include an indication in a report about the PRS resource ID from which the highest RSRP is measured, for example, among one or more PRS resources (e.g., all PRS resources) that the WTRU is configured to measure. The indication may assist the network with determining the WTRU's orientation angle.

A WTRU may perform one or more of the following to request a reconfiguration of a PRS related parameter. The WTRU may detect a drop in the RSRP of a measured PRS. The WTRU may perform RX beam sweeping and/or turn on an RX panel that is facing a different direction. On a condition that the RSRP does not improve after RX beam sweeping, the WTRU may decide to request reconfiguration of a PRS related parameter. The WTRU may send a request for reconfiguration of the PRS parameter. The request for reconfiguration may include one or more of the following (e.g., to assist an LMF with choosing an optimal parameter). The request may include a desired angle with respect to a predefined direction (e.g., geographical North) and the WTRU may receive a PRS from a different TRP. The request may include a measured RSRP for one or more Rx panels, beam sets, and/or beam indices (e.g., all Rx panels, beam sets, and/or beam indices). The request may include an Rx beam set/group, a panel ID, and/or a beam index at which a maximum RSRP is observed (e.g., the information may be helpful for the network to determine the WTRU's orientation angle). The request may include an AoA along with an RSRP.

Correction information may be provided/supported. A report (e.g., additional report) may be provided for low latency.

A WTRU may send measurement reports including, for example, RSRP and/or timing related information that may be related to paths (e.g., additional paths) to the network. The network may process measurement reports. The network may inform a WTRU about the results of LOS and/or NLOS path classification. The network may conduct positioning with low latency, for example, if a significant amount of time is not incurred for the measurement report to reach a network component (e.g., an LMF). Low latency positioning may be achieved, for example, if the WTRU conducts LOS and NLOS path classification. Classification may utilize processing (e.g., additional processing), which may consume battery power at a WTRU. In examples, WTRUs may not have a capability to conduct computations for LOS and NLOS path classification.

A WTRU may send the network measurement reports (e.g., additional measurement reports) for LOS or NLOS classification (e.g., which may be separate from the measurement report) and may be as described herein. For example, the WTRU may send additional information, which may include RSRP and/or timing related information related to the detected additional paths to a network (e.g., a gNB).

FIG. 3 illustrates an example of receiving standalone assisting information for a DL positioning method. As shown by example in FIG. 3, a WTRU may send information (e.g., additional information) to the gNB, for example, based on a request for a measurement report (e.g., additional measurement report) received from the gNB. In examples, one or more triggers for sending additional measurement reports to a gNB may be based on, for example, one or more of the following conditions (e.g., detected at the WTRU): detection of one or more changes in the WTRU's environment, an interference measurement, or a higher layer signaling/application indication.

A trigger for sending an additional measurement report to a gNB may be based on, for example, detection of one or more changes in the WTRU's environment. A WTRU may send additional measurements, for example, if the WTRU detects the presence and/or persistence of blockage conditions on the measured paths. A WTRU may send additional information (e.g., related to timing and/or angle), for example, based on a change (e.g., anticipated change) in one or more paths from LOS to NLOS and vice-versa.

A trigger for sending an additional measurement report to a gNB may be based on, for example, an interference measurement. A WTRU may send additional measurements, for example, if measuring interference on one or more paths, e.g., measured interference power is above a threshold (e.g., a predefined threshold) on the path(s).

A trigger for sending an additional measurement report to a gNB may be based on, for example, a higher layer signaling/application indication. For example, a WTRU may indicate information related to integrity and/or reliability on the paths. Integrity and/or reliability values may be determined, for example, as a function of RSRP measurements of one or more paths over a time duration (e.g., configured time duration).

Additional measurement information sent by a WTRU may be identified with an ID, for example, which may be correlated with an ID of another measurement report (e.g., original/first measurement report). A measurement report may be sent, for example, on a per-path basis. An identifier used for a path in additional measurement information may be, for example, an extension of an ID used for a path in another measurement report (e.g., original/first measurement report). A WTRU may send timing information (e.g., a timestamp) on a per-path or multipath basis, for example, to indicate the relevance/freshness of additional measurements, e.g., if sending the additional measurement information.

A function in a gNB may use the additional information, for example, to classify the paths (e.g., additional paths) into NLOS and LOS paths. A WTRU may receive path correction information from a gNB, which may include, for example, one or more of the following: multipath channel related information (e.g., delay spread, average delay, number of taps in multipath fading channel, relative delay between each tap, and/or relative power offset between each tap); a phase offset; a timing offset; a power offset; or a LOS and/or NLOS path classification result.

A WTRU may use path correction information to correct a position derived from the measurements obtained from PRS.

Correction information may be transmitted, for example, periodically. A WTRU may receive (e.g., receive periodically) correction information regarding a timing offset from the network. The correction information regarding the timing offset may be used to compensate for an unknown timing offset at a Tx or Rx transmission, or at a reception filter. The network may estimate a timing offset and report (e.g., transmit) it to the WTRU (e.g., via the correction information). The WTRU may apply the timing offset (e.g., provided by the network) to a timing related measurement such as a time of arrival or a time difference associated with an arrival. The timing offset (e.g., along with an unexpected offset in a multipath channel) may arise (e.g., occur) periodically. The correction information regarding the timing offset may be sent (e.g., from the network) to the WTRU periodically.

The correction information described herein may be sent to a WTRU via one or more of the following. The correction information may be sent via periodic transmission. The WTRU may receive configuration about the periodicity at which the correction information may be transmitted. The correction information may be sent via semi-persistent transmission. The WTRU may receive configuration about the periodicity at which the correction information is transmitted. The transmission may be terminated with a MAC-CE or after a duration of time (e.g., timer) expires (e.g., the duration of time and/or timer value may be configured). The correction information may be sent via aperiodic transmission. The WTRU may receive the correction information on an on-demand basis. For example, the WTRU may send a request for the correction information and may receive the correction information in response. The WTRU may receive correction information after receiving an indication from the network that the correction information is to be transmitted (e.g., based on preconfigured timing or transmission schedule).

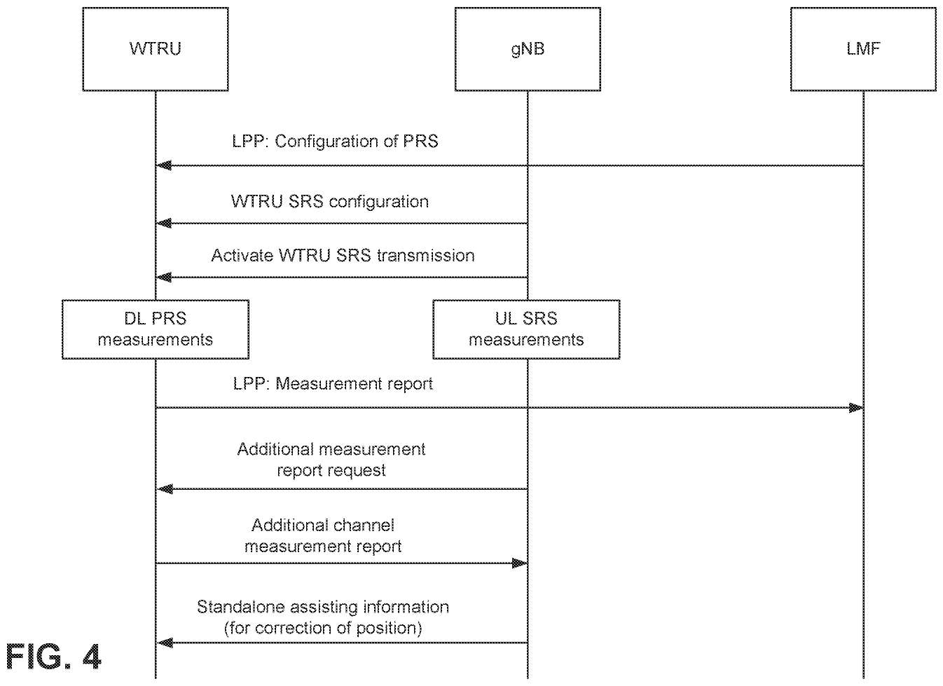

The method(s) described herein may be applicable to DL and DL and UL methods that use PRS (e.g., as described with respect to FIG. 4).

FIG. 4 illustrates an example for receiving standalone assisting information for a DL and UL positioning method. For example, a WTRU may transmit an SRS to a gNB. The gNB may make measurements. Standalone assisting information may be generated, for example, based on the SRS measurement results and a channel measurement report (e.g., additional channel measurement report). The WTRU may make corrections to the WTRU's position, e.g., using the standalone assisting information. The WTRU may send an SRS, for example, based on the additional measurement report request sent from the gNB.

LOS and NLOS classification may be achieved at low latency (e.g., and without WTRU processing), for example, by allowing/utilizing a function in gNB to process additional information.

A WTRU may have one or more of the following behaviors associated with the detection of multiple paths and/or WTRU-assisted, timing-based positioning.

With respect to multi-path detection and associated WTRU behaviors (e.g., for timing-based positioning methods such as DL-TDOA or multi-RTT), angle information and/or RSPR reporting with finer granularity may not be available at the WTRU or the network (e.g., a gNB), for example, in the presence of multiple paths associated with a channel. This may degrade the accuracy of WTRU positioning.

A WTRU may indicate to the network (e.g., to an LMF) the presence of a multi-path channel, for example, by reporting RSRP at a preconfigured granularity, which may be finer than that used for other RSRP measurements and/or reporting (e.g., finer than a default RSRP measurement/reporting granularity). The network may be able to determine the location information of the WTRU and/or to optimize a PRS configuration based on RSRP measured and/or reported with the finer granularity (e.g., to improve positioning accuracy). The default RSRP granularity described herein may include not having a specified or configured granularity, for example, which may indicate that the WTRU is to average the RSRP across resource elements (e.g., all resource elements) in the bandwidth allocated to the WTRU.

A WTRU may determine to use a default granularity for RSRP measurement and/or reporting. In examples, granularity for RSRP measurement may be defined by a resource element (e.g., RSRP per resource element), resource block (e.g., RSRP per resource block) and/or bandwidth (e.g., RSRP per bandwidth). In examples, a default granularity may include not having a configured granularity for RSRP. For example, with no granularity specified, the WTRU may compute a linear average of the received power of one more resources elements over the bandwidth occupied by PRS in received PRS symbols.

A WTRU may determine to and/or return a RSRP report with a finer granularity to the network (e.g., to an LMF) under at least one of the following conditions. The WTRU may report RSRP at a finer granularity than the preconfigured granularity if the WTRU detects multiple paths associated with a measurement (e.g., if the WTRU receives multiple copies of a PRS symbol at different times). The WTRU may report RSRP at a finer granularity than the preconfigured granularity if the WTRU detects a variation in RSRP across resource elements in a PRS symbol and/or a variation (e.g., standard deviation or variance in RSRP) that is above or equal to a threshold configured by the network (e.g., by an LMF or gNB). In examples, if the WTRU is preconfigured to report RSRP averaged over the bandwidth occupied by PRS and the WTRU detects variation in RSRP across resource elements, the WTRU may report RSRP averaged over each resource block in the bandwidth occupied by PRS. The WTRU may report RSRP at a finer granularity if the difference between the arrival times of multiple paths (e.g., the difference between the first path and the last path) is within the CP length of the OFDM symbol that includes a PRS.

The granularity of RSRP reporting may be configured, for example, for multi-path detection.

A WTRU may receive configuration information regarding the granularity of RSRP measurements and/or reporting from the network (e.g., from an LMF or gNB). The granularity for the RSRP measurements and/or reporting may be defined in at least one of the following formats. The granularity may be defined such that the RSRP per symbol and the power of received signals is averaged across resource elements in a PRS symbol (e.g., one PRS symbol). The granularity may be defined as RSRP per X RBs across at least one of the following time ranges: all received OFDM symbols that include a PRS; a preconfigured set of OFDM symbols that include a PRS; a repetition occasion in a PRS resource that includes a PRS; or a time range determined by the WTRU based on Doppler shift or spread or based on the number of paths the WTRU detects in a multi-path channel. “X” may be an integer configured by the network (e.g., an LMF). The WTRU may be given a set of values for the “X” and may determine which value of “X” to use depending on at least one of a number of paths the WTRU detects in the channel, capabilities of the WTRU (e.g., whether the WTRU has the capability to report RSRP at a fine resolution), or a configuration received by the WTRU from the network (e.g., from a gNB or LMF) regarding which value of “X” to use.

A WTRU may be configured to have one or more of the following behaviors in association with multi-path detection (e.g., after RSRP reporting). The WTRU may determine to keep reporting RSRP at a finer granularity and may return to a default granularity (e.g., no granularity) under at least one of the following conditions. The WTRU may return to reporting RSRP at the default granularity if the number of paths falls below a threshold configured by the network (e.g., by a gNB or LMF). The WTRU may return to reporting RSRP the default granularity if a variation in the RSRP across REs is smaller or equal to a threshold configured by the network (e.g., by a gNB or LMF).

A WTRU may be configured to have one or more of the following behaviors in association with multi-path detection (e.g., in SRSp transmission for multi-RTT). The WTRU may, e.g., if using a UL and DL positioning method such as one based on multi-RTT) determine to transmit multiple SRSp resources and may include multiple WTRU Rx−Tx time differences in a report. The WTRU may send the report to the network (e.g., to an LMF or gNB), for example based on a condition configured by the network (e.g., based on discovery of multiple paths in a channel). The WTRU may discover the multiple paths in the channel based on one or more of the following conditions. The WTRU may discover the multiple paths in the channel in response to detecting multiple paths in a measurement (e.g., the WTRU may receive multiple copies of a PRS symbol at different times). The WTRU may discover the multiple paths in the channel in response to detecting a variation in RSRP across resource elements in a PRS symbol and/or that the variation (e.g., a standard deviation or variance in RSRP) is above or equal to a threshold configured by the network (e.g., by an LMF or gNB). The WTRU may discover the multiple paths in the channel in response to detecting that there are multiple paths in a measurement and/or a delay time among the multiple paths that the WTRU is reporting is greater or equal to a threshold configured by the network. The delay time may be between the first path and the last path, between the first path and the second path, between the first path and a path associated with a path ID that may be indicated by the network (e.g., via DCI, a MAC-CE, RRC signaling, or LPP message), etc.

Multiple WTRU Rx−Tx time differences may be determined as follows. A first WTRU Rx−Tx time difference may be determined by a WTRU by at least computing a time difference between the time of arrival of a first instance of a PRS resource (e.g., PRS resource ID #1) and the transmission time of a first SRSp resource (e.g., SRSp resource ID #1), where the first SRSp resource may be a reference SRSp resource and the PRS resource may be a target PRS resource. A second WTRU Rx−Tx time difference may be determined by the WTRU by at least computing a time difference between the time of arrival of a second instance of the PRS resource (e.g., PRS resource ID #1) and the transmission time of a second SRSp resource (e.g., SRSp resource ID #2). A third WTRU Rx−Tx time difference may be determined by the WTRU by at least computing a time difference between the time of arrival of a third instance of the PRS resource (e.g., PRS resource ID #1) and the transmission time of a third SRSp resource (e.g., SRSp resource ID #3).

Resource and beam may be used interchangeably herein. In examples described herein, PRS resource ID #1 may be transmitted 3 or more times from a TRP and a different SRSp resource may be transmitted each of these times. The different SRSp resources may correspond to different directions of a SRSp beam. In examples, the WTRU may perform beam sweeping based on discovery of multiple paths in a channel. In the presence of the multiple paths in the channel, the NLOS path may be from a different angle than the LOS path (e.g., as described with respect to FIG. 2). The transmission of SRSp at different angles may provide measurements (e.g., additional measurements) for the LMF, for example, which may improve positioning accuracy.

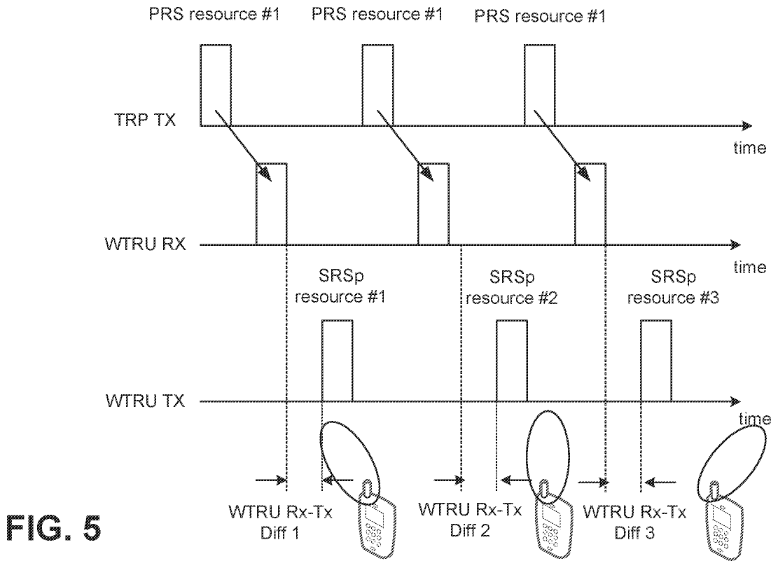

FIG. 5 illustrates an example in which the first, second, and third WTRU Rx−Tx time differences described herein are indicated as “WTRU Rx−Tx Diff 1”, “WTRU Rx−Tx Diff 2” and “WTRU Rx−Tx Diff 3”, respectively.

A WTRU may determine to transmit/transmit multiple SRSp's via respective SRSp resources (e.g., N SRSp resources, where N is an integer configured by the network such an LMF or gND), for example, upon discovery of multiple paths in a channel. One or more of the following may be performed. The WTRU may transmit SRSps on N−1 SRSp resources which may correspond to the neighboring beams of a reference SRSp resource. The WTRU may choose (e.g., select) the SRSp based on spatial direction information (e.g., azimuth, elevation, etc.) associated with DL-PRS resources and spatial relation information that associates SRSp resources and DL RS's.

A WTRU may receive spatial information from the network that associates a target PRS resource with N SRSp resources including a reference SRSp resource. A WTRU may receive angle information from the network that may include one or more of the following. The angle information may include an expected AoD and/or an indication of an AoD (e.g., a range of AoD where the center of the range indicates the expected AoD) of the reference SRSp resource. The angle information may include an expected AoA and/or an indication of an AoA (e.g., a range of AoA where the center of the range indicates the expected AoA) of the target PRS resource.

The number of SRSp resources, N, that the WTRU may use for transmission may be explicitly configured by the network (e.g., by an LMF or gNB) or implicitly configured (e.g., by spatial information). The WTRU may include (e.g., in a measurement report) an SRSp resource ID and/or an SRSp resource set ID associated with multiple Rx−Tx values (e.g., each of multiple Rx−Tx values). For example, “WTRU Rx−Tx Diff 2” as described with respect to FIG. 5 may be associated with SRSp resource #2.

A WTRU may (e.g., based on detection of multiple paths in a channel) report the WTRU Rx−Tx difference of time of reception (e.g., in terms of slot #, subframe #, frame #, symbol #) for one or more PRS resources (e.g., for each PRS resource) with respect to time of transmission (e.g., in terms of slot #, subframe #, frame #, symbol #, absolute time, relative time with respect to a reference time) of different PRS resources. For example, the WTRU may report (e.g., send an indication) the WTRU Rx−Tx difference for time of reception of PRS resource #1 with respect to time of transmission of SRSp resource #2, the WTRU Rx−Tx difference for time of reception of PRS resource #2 with respect to time of transmission of SRSp resource #2, the WTRU Rx−Tx difference for time of reception of PRS resource #3 with respect to time of transmission of SRSp resource #2, etc (e.g., to a network entity).

A WTRU may be configured to receive one or more of the following from a network (e.g., from an LMF or a gNB). The WTRU may be configured to receive a set of PRS resources and/or an indication to associate path(s) (e.g., path IDs such as LOS path IDs and/or NLOS path IDs) with SRSps (e.g., respective SRSp resources). The WTRU may be configured to transmit one or more SRSp resources with respective IDs. The WTRU may be configured to receive spatial relation configuration information from the network that may indicate a DL PRS associated with an SRPp, an SRSp transmission direction, and/or a reception beam and/or direction. In examples, spatial relation may be association of SRSp resource ID(s) with a DL PRS resource ID, indicating the PRS on PRS resource and SRSp on SRSp resources are transmitted and/or received in the same direction. The WTRU may be configured to receive one or more PRS resources and the WTRU may detect multiple paths (e.g., based on the measurements such as time of arrival or angle of arrival, made on the received PRS on PRS resources). The WTRU may be configured to assign a path ID to a path (e.g., respective path ID to a respective path) and/or may associate a path ID (e.g., a respective path ID) with an SRSp ID (e.g., respective SRSp ID), for example based on aligning a path direction and/or SRSp spatial relation information received by the WTRU. The WTRU may be configured to send an association of path IDs to SRSp IDs to the network. The WTRU may be configured to transmit an SRSp in an SRSp resource with an associated SRSp ID, for example, for a path ID (e.g., each path ID) and/or based on an association of the path ID to the SRSp ID. The WTRU may determine an Rx−Tx time difference from the reception of a PRS to the transmission of an SRSp that may be associated with a path/path ID (e.g., a respective SRSp may be sent for each of the first path and the second path, where each path may include a respective path ID). The WTRU may report (e.g., to a network) a respective Rx−Tx time difference for a respective path/path ID).

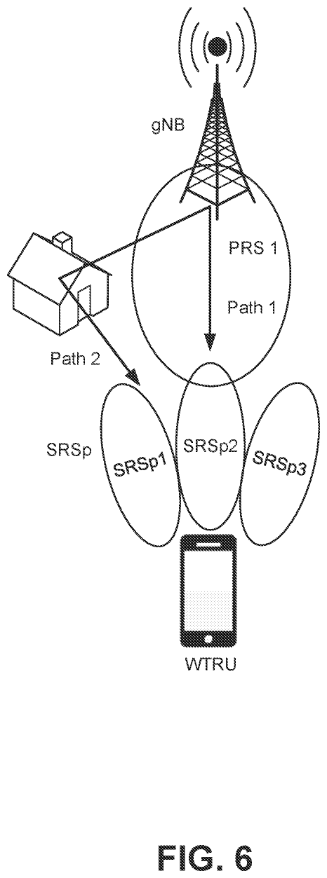

FIG. 6 illustrates an example of a spatial relation configuration associating a PRS with SRSp(s). In examples, three SRSp resources (e.g., SRSp1, SRSp2, and SRSp3) may be associated with a PRS resource (e.g., PRS1). A WTRU may receive configuration information from a network (e.g., a gNB, an LMF, etc.) that may associate the PRS resource (e.g., PRS1) with one or more of the SRSp resources (e.g., all of the SRSp resources such as SRSp1, SRSp2, and/or SRSp3). The WTRU may report an Rx−Tx difference for one or multiple paths (e.g., path-dependent Rx−Tx reporting). For example, the WTRU may report an Rx−Tx difference based on the arrival time or reception time of a PRS (e.g., received based on PRS resource PRS1), received from the direction path 2 (e.g., as shown in FIG. 6), with respect to the transmission time of an SRSp associated with path 2 (e.g., SRSp is transmitted based on SRSp resource SRSp1 toward the direction of path 2). The WTRU may use an Rx beam steered toward SRSp resource SRSp1 and may measure the time of arrival for the PRS received, for example, using that Rx beam. The WTRU may report an Rx−Tx difference based on the arrival time of a PRS (e.g., received using PRS resource PRS1) along path 1 (e.g., as shown in FIG. 6) with respect to the transmission time of an SRSp associated with path 1 (e.g., the SRSp may be transmitted using SRSp resource SRSp2). The WTRU may use an Rx beam steered toward SRSp resource SRSp2 and may measure the time of arrival for the PRS received using that Rx beam. In examples, the WTRU may report (e.g., send an indication of) the WTRU Rx−Tx difference for time of reception of PRS on PRS resource PRS1 received along path 1 with respect to time of transmission of SRSp on SRSp resource SRSp2 which is transmitted along path 1 and the WTRU Rx−Tx difference for time of reception of PRS on PRS resource PRS1 which is received along path 1 with respect to time of transmission of SRSp on SRSp resource SRSp1 which is transmitted along path 2, etc. (e.g., to a network entity).

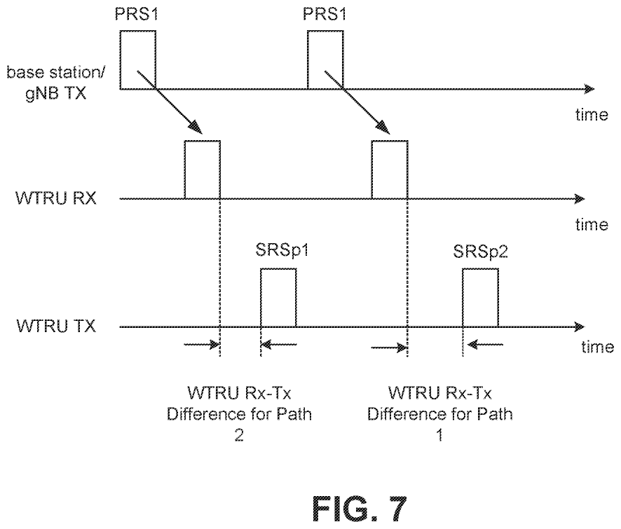

FIG. 7 illustrates how the WTRU may determine an Rx−Tx difference. A WTRU may determine the presence of multiple paths (e.g., multiple transmission/reception paths), for example, if a PRS is received (e.g., using a PRS resource) via multiple paths within a time window (e.g., a preconfigured time window). The WTRU may receive configuration information regarding the time window from a network (e.g., from a base station or gNB, from an LMF, etc.). In examples, the configuration information may indicate that the duration of the time widow is 2 milliseconds (ms). The WTRU may assign a path ID for a detected path (e.g., each detected path), for example, if the WTRU makes measurements on multiple copies of the PRS (e.g., the PRS resource used to transmit the PRS) within the time window. In examples, the WTRU may be configured to not include PRS resources that have a time of arrival outside of the time window in the determination of the multiple paths.

A WTRU may be configured with one or more of the following behaviors with respect to terminating an action performed in association with multi-path detection (e.g., after performing RSRP reporting as described herein). The WTRU may report WTRU Rx−Tx differences with respect to a reference SRSp resource (e.g., a single reference SRSp resource), for example the WTRU may switch back to a default reporting behavior if one or more of the following conditions is satisfied: the number of paths falls below a threshold configured by the network (e.g., by a gNB or LMF); a variation in the RSRP across REs is less than or equal to a threshold configured by the network (e.g., by a gNB or LMF); or the WTRU receives an indication from the network (e.g., via DCI, an MAC-CE, RRC signaling, or LPP message) to report WTRU Rx−Tx difference with respect to a reference SRSp resource.

As described herein, a WTRU may use a first positioning method (e.g., based on multi-RTT with a single SRSp resource to report Rx−Tx time difference). The WTRU may switch (e.g., switch autonomously) to a second positioning method based on a condition being met (e.g., detection of multiple paths in a channel). The second position method may be, for example, based on multi-RTT with N SRSp resources (e.g., including a reference SRSp resource) to report Rx−Tx time differences. The WTRU may switch back to the first position method, for example, based on a termination condition being satisfied (e.g., if the WTRU no longer observes multiple paths in the channel).

A WTRU may be configured to perform WTRU-based positioning in the presence of multiple paths. WTRU-based DL positioning (e.g., based on TDOA or AoD) may comprise the WTRU computing its position based on measurements made on a received PRS and reporting to the network (e.g., an LMF) the WTRU's location information. The WTRU may not send a measurement report to the network (e.g., an LMF). In examples (e.g., in the presence of multiple paths that the WTRU observes in one or more PRS's such as one or more PRS beams and/or PRS resources that the WTRU receives), the WTRU may not be able to indicate to the network (e.g., an LMF) the presence of the multiple paths in a channel and as a result positioning accuracy for the WTRU may deteriorate. The PRS's (e.g., PRS beams and/or PRS resources) may belong to different PRS resource sets and/or may be associated with different TRPs, absolute radio-frequency channel number (ARFCNs), PRS-IDs, cell IDs, and/or CellGlobalDs.

A WTRU may receive one or more criteria and/or conditions from the network for using single-path based location estimation. The WTRU may determine to use/use measurements that correspond to a path to derive the location estimation, for example, if a minimum number of measurements are available (e.g., measurements related to RSRP and time of arrival are available for the path) or conditions (e.g., RSRP of the path is above the threshold, relative difference between RSRP of the path and RSRP of other detected paths is above the threshold, etc.) are satisfied. The WTRU may report the location estimation to the network (e.g., an LMF) and may indicate to the network (e.g., the LMF) that single-path measurements are used to derive the location estimation. The WTRU may switch to multi-path based derivation of location estimation, for example, if one or more of the criteria or conditions are not satisfied.

A WTRU may receive one or more criteria from the network for multi-path based location estimation. The WTRU may derive a location estimation based on the criteria and may report the location estimation to the network (e.g., to an LMF). In examples, the WTRU may detect multiple paths in a channel. The WTRU may report the number of paths detected along with the location information to the network. The WTRU may send the location information and/or the multi-path information via a message such as an LPP message (e.g., a “LPP Provide Location Information” message).

A WTRU may determine to report multiple location information, for example, if the WTRU detects multiple paths in a channel in at least one of the PRS's that the WTRU receives and on which the WTRU makes measurements. The WTRU may determine the criteria used to derive the location information and may report the location information to the network (e.g., to an LMF). The WTRU may determine to include single location information, for example, if the WTRU does not detect multiple paths in the channel. The WTRU may receive an indication from the network (e.g., from an LMF) to report single and/or multiple location information (e.g., via DCI, an MAC-CE, RRC signaling, LPP message, etc.).

A WTRU may (e.g., based on detection of multiple paths) report multiple location information and/or may associate the location information with the criteria used by the WTRU to derive the location information. In examples (e.g., if using methods such as TDOA or AoD), the WTRU may make measurements on multiple PRS's and may observe multiple paths in one or more of the PRS's. The WTRU may report to the network (e.g., to an LMF) multiple location information and/or its association with the paths based on detecting multiple paths in a channel or based on an indication from the network (e.g., from an LMF) to report the multiple location information and its association with the multiple paths.

In examples, a WTRU may detect Ni paths in a channel for PRS resource #i (e.g., which may be associated with PRS beam #i). The WTRU may derive location information using one or more of the following and may indicate to the network (e.g., to an LMF) that the location information provided to the network (e.g., to the LMF) is derived using one or more of the following.

The WTRU may derive the location information based on one or more paths (e.g., all paths) that the WTRU observes in measurements associated with one or more PRS resources (e.g., all PRS resources). In examples, the WTRU may derive the location information based on Ni paths (e.g., all Ni paths) for PRS resource i for values of I (e.g., all values of i) on which the WTRU makes measurements, where i may be an index of a PRS resource configured by the network (e.g., an LMF) and/or detected by the WTRU.

The WTRU may derive the location information based on a path determined based on one or more of the following criteria. The criteria may be applicable to one or more PRS resources (e.g., all the PRS resource) on which the WTRU makes measurements. The criteria may be configured by the network (e.g., by an LMF). The WTRU may determine the location information based on a path that has the largest RSRP among the Ni paths that the WTRU detects for a PRS resource index I (e.g., PRS resource index i). The WTRU may determine the location information based on the path that has the earliest time of arrival (e.g., the first path) among the Ni paths that the WTRU detects for a PRS resource index i (e.g., each PRS resource index i). The WTRU may determine the location information based on a path with an indicated order of arrival. In examples, the WTRU may determine the location information based on the path that has the second earliest time of arrival and may indicate to the network that the path is used to derive the location information. The WTRU may determine the location information based on measurements associated with one or more paths (e.g., one or more observed paths for each PRS resource index i). In examples, if the relative delay of one or more paths compared to the path with the earliest ToA is less than or equal to a preconfigured threshold, e.g., which may be configured by the network such as by an LMF or gNB, the WTRU may use measurements associated with the one or more paths to determine the location information. In examples, if the relative RSRP difference of one or more paths compared to the path with the strongest RSRP is less or equal to a preconfigured threshold (e.g., which may be configured by the network such as by an LMF or gNB), the WTRU may use measurements associated with the one or more paths to determine the location information.

The WTRU may derive the location information based on one or more selected paths and the WTRU may report measurements (e.g., RSRP, relative time difference with respect to the time of arrival of a reference path, etc.) associated with the selected paths.

The conditions and/or criteria described herein may be configured by the network (e.g., by an LMF). A WTRU may receive the configuration(s), for example, prior to receiving a PRS. A WTRU may receive the configuration(s), for example, if the WTRU reports the presence of multiple paths in a channel. The WTRU may receive an indication from the network (e.g., an LMF) about which criterion or criteria to use. The indication may be received, for example, via DCI, an MAC-CE, RRC signaling, LPP message, etc.

In examples, a WTRU may be configured by the network (e.g., by an LMF) to receive a first PRS resource (e.g., PRS resource #1), a second PRS resource (e.g., PRS resource #2), and/or a third PRS resource (e.g., PRS resource #3), which may be transmitted by different TRPs located at different locations. From the WTRU's perspective, respective PRS beams corresponding to the PRS resources may be transmitted from different directions. The WTRU may observe one, three, and two paths based on measurements made on PRS resource #1, PRS resource #2 and PRS resource #3, respectively. Based on the largest RSRP criterion described herein, the WTRU may choose a path from which the largest RSRP is obtained among the three and two paths detected in the measurements on PRS resource #2 and PRS resource #3, respectively, and may use the measurements from the chosen path (e.g., RSRP, time of arrival, angle of arrival, etc.) to derive location information. Since one path (e.g., only one path) is observed in the measurements obtained from PRS resource #1, the WTRU may use the measurements on that path to derive location information.

A WTRU may indicate to the network (e.g., to an LMF) the path information (e.g., a PRS resource ID with which the WTRU observes multiple paths) used to derive location information. The WTRU may receive an indication from the network (e.g., from an LMF and/or via an LPP message) for the WTRU to report multiple location information corresponding to different criteria. The WTRU may report the multiple location information based on one or more of the criteria or conditions described herein. In examples, the WTRU may report one location information obtained using the largest RSRP criterion and another location information obtained using the earliest time of arrival criterion.

A WTRU may include one or more of the following in a report to the network (e.g., to an LMF). The WTRU may include expected location information and/or an indication of location information (e.g., the lower and upper bounds of the location information with respect to the expected location information) in a report to the network. The WTRU may include one or more PRS resource IDs with which the WTRU detects multiple paths (e.g., based on measurements performed by the WTRU) in a report to the network.

A WTRU may report expected location information and an indication associated with the location information (e.g., the lower and upper bounds of the location information, standard deviation or variance of the location information, etc.) for WTRU-based AoD based positioning to indicate to the network (e.g., to an LMF) the uncertainty in measurements due to multiple paths being observed in the measurements performed on PRS resources that the WTRU receives. The WTRU may receive configuration information from the network to report expected location information and/or uncertainty in location information.

A WTRU may be configured to determine an RSRP associated with a transmission/reception path (e.g., a first path). The WTRU may receive a request from the network to report the RSRP. In examples (e.g., if the WTRU is configured to apply a WTRU-assisted positioning technique such as DL-AoD, DL-TDOA, etc.), the WTRU may receive an indication from the network to report a first path RSRP associated with one or more PRS resources that the WTRU is configured to measure (e.g., multiple paths may be detected for the one or more PRS resources). In examples (e.g., if the WTRU is configured to apply a WTRU-based positioning technique such as DL-AoD, DL-TDOA, etc.), the WTRU may receive an indication from the network to use a first path RSRP to determine a location estimation (e.g., the first path RSRP may be associated with one or more PRS resources for which multiple paths are detected). The WTRU may receive the indication described herein via an LPP message, via RRC signaling, in a MAC-CE or DCI, etc.

If a WTRU is capable of detecting multiple paths, the WTRU may send a message (e.g., an acknowledge message in response to receiving an indication to report a first path RSRP) to the network, for example, via LPP, RRC signaling, in a MAC-CE, or UCI. If the WTRU is not capable of detecting multiple paths, the WTRU may send a response (e.g., an NACK message) to the network (e.g., via LPP, RRC signaling, MAC-CE, or UCI) indicating the lack of capabilities. The WTRU may send capability information associated with the detection of multiple paths (e.g., including the capability to measure a first-path RSRP) to the network, for example, prior to receiving an indication from the network to report and/or use a first path RSRP for location estimation.

A WTRU may select a path with the earliest time of arrival (e.g., a first path) from multiple paths (e.g., Ni paths) that the WTRU may detect for a PRS resource (e.g., each PRS resource such as a PRS resource associated with a PRS resource index i). The WTRU may use the selected path for location estimation, for example, if the WTRU is configured to apply a WTRU-based positioning technique for the location estimation. The WTRU may use the selected path for RSRP reporting (e.g., RSRP measured for a PRS associated with the path), for example, if the WTRU is configured to apply a WTRU-assisted positioning technique such as DL-AoD, DL-TDoA, etc.

If a WTRU receives an indication from the network to report a first-path RSRP and the WTRU does not detect multiple paths for one or more PRS resources, the WTRU may report an RSRP for the one or more PRS resources. The WTRU may be configured to not include an indication that the reported RSRP corresponds to a first path (e.g., or to indicate that the reported RSRP is not associated with a first path), for example, if the WTRU does not detect multiple paths for the one or more PRS resources.

A WTRU may be configured to perform one or more of the following if generating (e.g., measuring and/or reporting) an RSRP for a first path. The WTRU may report an accumulated or average received power (e.g., an RSRP) for a first path over a time window or a number of time units (e.g., symbols, PRS resources, slots, frames, or other time units) and consistent measurements may be reported and/or used by the WTRU for location estimation. The duration of the time window or the number of time units may be preconfigured, for example, by a network. The WTRU may include a PRS resource ID associated with the measured RSRP for the first path if the WTRU reports the RSRP for the first path to the network. The WTRU may indicate in the report that the reported RSRP corresponds to a first path for the PRS resource ID.

A WTRU may be configured (e.g., by a network) to make measurements for multiple paths during a time window (e.g., a preconfigured time window). The duration of the time window may be based on channel characteristics such as delay spread. In examples, the WTRU may be configured with two time windows and may receive configuration for the time windows (e.g., duration, start time, end time, periodicity, etc.). The WTRU may use a first time window (e.g., of the two configured time windows) whose duration may be determined, for example, based on the delay spread of a channel to determine the number of paths the WTRU may measure. For example, the WTRU may be preconfigured with a look-up table associating durations of the window with delay spreads of the channel. Based on the measured spread value, the WTRU may refer to the look-up table and determine the duration of the window. The WTRU may be configured to not consider a replica (e.g., any replica) of a PRS received by the WTRU beyond the duration of the first time window as a part of the multiple paths. A PRS may be transmitted by the network (e.g., by a base station or gNB, by a TRP, etc.) periodically or semi-persistently with or without repetitions.

The WTRU may use a second time window (e.g., of the two configured time windows described herein) to accumulate the received power of a PRS (e.g., periodically or semi-persistently transmitted from the network and received by the WTRU) for detecting paths and/or reporting RSRP (e.g., per path) to the network. The WTRU may include the duration of the first and/or second time window if the WTRU reports the accumulated RSRP (e.g., or averages RSRP per path). The WTRU may assign a path ID to a path (e.g., each path) detected during the first time window and associate the path (e.g., path ID) with the average/accumulated RSRP measured for the path.

In examples, the WTRU may, during the second time window described herein, accumulate the RSRP for a path (e.g., each path) that the WTRU detects in the first time window. In examples, the WTRU may not accumulate the RSRP, for example, if the RSRP is below a preconfigured threshold. The WTRU may be configured with the second time window for each path in the multipath channel. For example, if the WTRU detects 3 paths in the channel, the WTRU may receive configurations from the network of the window configuration(s) which may be applicable to each of the 3 paths detected by the WTRU. The WTRU may associate detected multiple paths with relative delays with respect to the first path and may report the number of paths, RSRP, and relative delays to the network (e.g., LMF or gNB). For example, with respect to the first path (e.g., the path along which the earliest time of arrival of PRS is measured), the WTRU may determine to associate the second path with a delay T1 indicating along the second path, the WTRU receives the PRS T1 later than the time when a PRS is received along the first path. The WTRU may determine to associate the third path with a delay T2 indicating along the third path, the WTRU receives the PRS T2 later than the time when a PRS is received along the first path. The unit of the delay may be expressed in terms of seconds, number of symbols, slots, frames, or subframes.

A WTRU may declare a path to be a part of multiple channels, for example, if an RSRP (e.g., accumulated or averaged during the second time window) is above a preconfigured threshold. A WTRU may not declare a path to be a part of multiple channels, for example, if an RSRP (e.g., accumulated or averaged during the second time window) is above the preconfigured threshold.

In examples (e.g., based on the expiration of the second time window), a WTRU may determine a first path based on the earliest time of arrival during the first time window. In examples, if the accumulated/averaged RSRP corresponding to the earliest path in the time window is below a preconfigured threshold, the WTRU may determine that the next earliest path in the time window with an accumulated/averaged RSRP above the preconfigured threshold is the first path.

A WTRU may use the first and/or second time window described herein to accumulate or average an RSRP, for example, even if the WTRU does not detect multiple paths associated with a PRS. For example, the WTRU may accumulate or average the RSRP for an observed PRS.

A WTRU may repeat the operations described herein for multiple PRS resources (e.g., all PRS resources) in a PRS resource set configured for the WTRU.

WTRU-assisted or WTRU-based positioning techniques may be based on a first path.

In examples (e.g., for WTRU-based positioning), a WTRU may indicate to a network that a location estimate is obtained based on one or more of the following. The WTRU may indicate that the location estimate is obtained using a first path RSRP (e.g., only the first path RSRP). The WTRU may indicate that the location estimate is obtained using a combination of first path RSRP(s) and RSRP(s) of PRS resources for which multiple paths were not detected. The WTRU may indicate that none of the RSRPs used to derive the location estimate is the first path.

In examples (e.g., for WTRU-assisted positioning), a WTRU may indicate (e.g., to a network) an associated PRS resource ID, a PRS resource set ID, a TRP ID, and/or a frequency layer ID from which a first path RSRP is obtained.

A WTRU may be configured to measure multiple PRS resources in a PRS resource set. A PRS resource (e.g., each PRS resource) may be transmitted using a respective Tx beam (e.g., different Tx beam), which may aim at a different direction from the transmitter side. A beam associated with a PRS resource may be pointed along a LOS direction (e.g., as described with respect to FIG. 2). A WTRU may determine to report and/or use a first path RSRP for location estimation for WTRU-assisted or WTRU-based positioning, respectively. The WTRU may determine the first path RSRP to report/use for location estimation based on one or more of the following criteria.

The WTRU may report and/or use the RSRP of a first path corresponding to a (e.g., each) PRS resource (e.g., the WTRU may measure a time of arrival for the PRS resource and/or measure the RSRP of the PRS resource with the earliest time of arrival if the WTRU detects multiple paths for the PRS resource). In examples, if the WTRU does not detect multiple paths, the WTRU may report an RSRP for the PRS, e.g., without associating the RSRP with a path.

The WTRU may measure a first-path RSRP for a PRS resource with which the WTRU detects multiple paths. The WTRU may measure an RSRP for a PRS, for example, if the WTRU detects a path (e.g., single path) for the PRS. The WTRU may determine the highest RSRP among the first-path RSRP and the RSRP for the PRS resource. The WTRU may report the highest RSRP to a network (e.g., for WTRU-assisted positioning) or use the highest RSRP for location estimation (e.g., for WTRU-based positioning).

A WTRU may select a first path RSRP from the PRS resources for which multiple paths are detected. The WTRU may report and/or use the highest first path RSRP among the first path RSRPs described herein obtained for the PRS resources.

A WTRU may measure a time of arrival and/or an RSRP for a PRS resource (e.g., each PRS resource). The WTRU may measure multiple times of arrival for a PRS resource, for example, if multiple paths are detected for the PRS. The WTRU may determine the PRS resource with the earliest time of arrival across the measured times of arrival for multiple PRS resources (e.g., all PRS resources) in a PRS resource set and may report/use an RSRP along with an associated PRS ID and/or PRS resource set ID.

In examples described herein, “RSRP” may be replaced by “averaged RSRP” or “accumulated RSRP.” A WTRU may determine a first path, an averaged RSRP, or an accumulated RSRP using the first and/or second time window described herein. A WTRU may determine the presence of multiple paths using the first and/or second time window described herein. A WTRU may repeat the operations described herein for one or more PRS resource sets (e.g., each PRS resource set) and/or one or more TRPs (e.g., each TRP) from which PRS(s) are transmitted such that the WTRU may determine a first path ID for the PRS resource set(s) and/or TRP(s). A WTRU may report a first path RSRP for one or more PRS resource sets (e.g., for each PRS resource set) and/or one or more TRPs (e.g., for each TRP), for example, for WTRU-assisted positioning. The WTRU may include a time of arrival corresponding to a first path for a PRS, for example, where the time of arrival may be expressed in terms of a system frame number, a slot number, an absolute radio-frequency channel number, a cell global ID, a physical cell ID, a subframe number, and/or a symbol number.

A WTRU may be configured with multiple sets of PRS resources and the WTRU may receive a request from a network to report a first path RSRP and/or use a first path RSRP for location estimation. The WTRU may measure a time of arrival and/or an RSRP for a PRS resource (e.g., each PRS resource) in a resource set (e.g., each resource set). The WTRU may measure multiple times of arrival for a PRS resource, for example, if multiple paths are detected for the PRS. The WTRU may determine the PRS resource with the earliest time of arrival across the measured times of arrival for multiple PRS resources (e.g., all PRS resources) in multiple resource sets (e.g., all resource sets). The WTRU may report/use an RSRP associated with the PRS resource along with an associated PRS ID and/or PRS resource set ID.

A WTRU may be configured to perform single-path based location estimation. In examples, the WTRU may determine to use measurements from one or more PRS resources from which the WTRU does not observe multiple paths. The WTRU may be configured by the network (e.g., by an LMF) to receive a first PRS resource (e.g., PRS resource #1), a second PRS resource (e.g., PRS resource #2), a third PRS resource (e.g., PRS resource #3), and/or a fourth PRS resource (e.g., PRS resource #4), for example, which may be transmitted from different TRPs located at different locations. From the WTRU's perspective, PRS beams corresponding to respective PRS resources may be transmitted from different directions. The WTRU may observe one path, three paths, one path, and one path from measurements made on PRS resource #1, PRS resource #2, PRS resource #3, and PRS resource #4, respectively. The WTRU may, e.g., in such a case, decide to use PRS resource #1, #2, and #4 to determine a location estimate, and may reject the measurements from PRS resource #3, for example, due to the presence of multiple paths in the measurements. The WTRU may indicate to the network (e.g., to an LMF) that received PRS(s) from which only single path is measured are used to derive the location estimate.

A WTRU may determine to perform the single-path based location derivation or multiple-path based location derivation described herein based on one or more conditions. The WTRU may use the single-path based location derivation, for example, if one or more of the following conditions are satisfied. The WTRU may use the single-path based location derivation if the number of PRS resources from which the single path is observed is above or equal to a preconfigured threshold (e.g., configured by the network such as by an LMF or gNB). In examples, the minimum number of measurements may be available for the WTRU to derive the location estimate. The WTRU may use the single-path based location derivation if the minimum or average RSRP of the received PRS resource(s) from which the single path is observed is above or equal to a preconfigured threshold (e.g., configured by the network such as by an LMF or gNB). In examples, the received signal power may be large enough for the WTRU to derive the location estimate. The WTRU may use the single-path based location derivation if, for one or more PRS resources (e.g., all PRS resources) from which more than one path is observed, the relative time difference between the first path (e.g., having the earliest time of arrival) and the last path (e.g., having the latest time or arrival) is below or equal to a preconfigured threshold (e.g., configured by the network such as by an LMF or gNB). In examples, multiple paths arriving close enough in time with each other may be considered as a single path. The WTRU may use the single-path based location derivation if one of the paths is indicated as line of sight from the network. A WTRU may determine to perform (e.g., switch to performing) the multiple-path based location derivation described herein, for example, if none of conditions are satisfied.

If the single-path based measurements are used, the WTRU may indicate to the network (e.g., an LMF) that single-path based derivation of location estimate is used and the WTRU may indicate which criterion or criteria are used to determine which method is used to derive the location estimate.

If the multi-path based measurements are used, the WTRU may indicate to the network (e.g., to an LMF) that multi-path based derivation of the location estimate is used and the WTRU may indicate which criterion or criteria are used to determine which method is used to derive the location estimate. The WTRU may receive an indication (e.g., an explicit indication) from the network (e.g., from an LMF) regarding whether the WTRU is to use single-path or multi-path based measurements to derive the location information. The indication may be received, for example, via DCI, an MAC-CE, RRC signaling, LPP message, etc.

The conditions or criteria related to multi-path based location estimate derivation may be configured separately from the conditions or criteria related to single-path based location estimate derivation. A WTRU may request that the network (e.g., an LMF) send configuration information related to the conditions or criteria to the WTRU, for example, if the WTRU determines that single-path based location estimate derivation may not be used by the WTRU.

A WTRU may be configured with one or more of the following behaviors in association with detection of multi-path and/or angle-based positioning. For angle-based positioning (e.g., AoD), the timing information of a multi-path channel may not be available and the network may not be able to obtain directional information for one or more paths (e.g., for each of the one or more paths).

A WTRU may observe multiple paths in a channel (e.g., through RSRP at a finer resolution). The presence of multiple paths in the channel may correspond to frequency selectivity in the channel. For example, the WTRU may not observe frequency selectivity of the channel if RSRP for PRS is averaged over the bandwidth the PRS occupies. The WTRU may observe frequency selectivity, for example, if RSRP is averaged per resource block in the bandwidth the PRS occupies. The WTRU may determine the number of Rx beams the WTRU may use for Rx beam sweeping. The WTRU may perform Rx beam sweeping, for example, using the determined number of Rx beams and/or may report RSRP (e.g., at a finer granularity) per Rx beam for a PRS resource. The WTRU may indicate to the network that beam sweeping is conducted and that the orientation of the WTRU has not changed.

In examples, a WTRU may detect multiple paths and may determine a number of Rx beams to be used for Rx beam sweeping. The number of Rx beams may be determined by one or more of a variance in RSRP across the frequency domain, an uncertainty range configured by the network, an expected AoD of a DL-PRS from the network (e.g., from an LMF), or a value configured by the network. In examples, uncertainty range may include an expected AoD and/or an uncertain AoD (e.g., a range of AoD where the center of the range indicates the expected AoD) associated with a reference SRSp resource. In examples uncertainty range may include an expected AoA and/or an uncertain AoA (e.g., a range of AoA where the center of the range indicates the expected AoA) of a target PRS resource.

A WTRU may be configured to report RSRP (e.g., at a finer granularity compared to the pre-configured granularity to report RSRP) and/or other quantities (e.g., a phase difference with respect to a reference Rx for each Rx beam). The WTRU may indicate (e.g., indicate explicitly) that the WTRU did not rotate. The WTRU may report relative AoA (e.g., relative to a reference point such as Rx beam 1) for an additional measurement or additional path (e.g., each additional measurement or additional path).

A WTRU may not be expected to rotate during Rx beam sweeping and the WTRU may indicate to the network that the orientation of the WTRU did not change.

A WTRU may be configured to perform TEG measurement and/or reporting. When referred to herein, TEG may include transmission and/or reception parameters (e.g., beam, panel, port, etc.) used by a WTRU that is associated with the TEG.

A WTRU may be configured to group different timing errors into a TEG, for example, based on the QoS requirement(s) of a positioning service. The QoS requirements may include, for example, a positioning accuracy requirement. In examples, the WTRU may group one or multiple UL transmissions or DL receptions into a TEG if the timing error between any UL transmission and DL reception in the group is less than a threshold. The threshold may be determined based on one or more QoS requirements of a positioning service (e.g., a positioning accuracy requirement). In examples, the WTRU may be associated with multiple antenna panels for UL-PRS transmission for positioning uses. For a low positioning accuracy requirement, the WTRU may group UL-PRS transmissions of different antenna panels into a TEG. For a high positioning accuracy requirement, the WTRU may group UL-PRS transmissions of the same antenna panel into a TEG. For more stringent positioning accuracy requirements, the WTRU may group UL-PRS transmissions of one antenna port into a TEG. An antenna port (e.g., each antenna port) may be associated with a (e.g., one) TEG (e.g., respective TEG).

A WTRU may be configured to determine an association between TEGs and UL-PRS and/or DL-PRS resources. In examples, the WTRU may be indicated (e.g., via network configuration) the association between a TEG and a set of resources (e.g., DL-PRS reception resources or UL-PRS transmission resources). The WTRU may (e.g., based on the indicated association) use the same set of transmission and/or reception parameters for (e.g., corresponding to the same TEG) the set of resources for transmission and/or reception. In examples, the WTRU may use an Rx beam to represent a TEG. In examples, the WTRU may be indicated (e.g., configured) to use the same TEG for the reception of a set of DL-PRS resources, and the WTRU may use the same Rx beam for DL-PRS reception in the indicated set of resources. In examples, the WTRU may be indicated (e.g., configured) to use the same TEG for a set of UL-PRS transmissions. The WTRU may associate an antenna panel to a TEG, and the WTRU may use an antenna panel (e.g., one antenna panel) for UL-PRS transmission in the set of indicated UL-PRS resources.

A WTRU may be configured (e.g., via RRC signaling) or indicated (e.g., via DCI) to use the same TEG for a set of DL-PRS and/or UL-PRS resources. In examples, the WTRU may be configured to use a TEG transmission/reception for a set of resources. In examples, the WTRU may determine to use a beam or panel for the reception of a set of DL-PRS resources. This may help the network cancel out one or more TEGs associated with a same source (e.g., a same beam reception).

A WTRU may be configured (e.g., via RRC signaling) or indicated (e.g., via DCI) to use multiple TEGs for DL-PRS reception and/or UL-PRS transmission. In examples, the WTRU may determine to use multiple TEGs for DL-PRS reception and/or UL-PRS transmission in a set of resources. In examples, the WTRU may be configured to perform beam sweeping reception for DL-PRS reception in a set of resources and/or to perform beam sweeping transmission for UL-PRS transmission in a set of resources. This may help the WTRU average the timing errors from the WTRU side.

A WTRU may be configured to report TEG information to the network. The WTRU may perform one or more of the following TEG information reporting. The WTRU may perform periodic TEG reporting. In examples, the WTRU may be configured to send TEG information periodically, where the periodicity may be configured based on a positioning service. The WTRU may be configured to perform trigger-based reporting and may report TEG information based on one or more of the following events (e.g., triggering events): detection of a delta difference from a previous TEG reporting or use of a different set of TEG(s) to perform DL-PRS reception and/or UL-PRS transmission (e.g., the WTRU may perform TEG reporting if it uses a different port, beam, or antenna panel to transmit UL-PRS and/or receive DL-PRS).

A WTRU may be configured to request the TEG information of a base station (e.g., a gNB). The WTRU may request the TEG information of the base station (e.g., gNB), for example, to be used in a WTRU-based positioning method. The WTRU may be configured with one or more triggering events for sending a TEG information request. The triggering events may include one or more of the following: a positioning error being greater than a threshold or a variation in a position measurement being greater than a threshold.

A WTRU may be configured to receive TEG information from the network. The WTRU may receive the TEG information from the network (e.g., regarding a gNB Tx and/or Rx TEG) to be used in a WTRU-based positioning method. The TEG information may be provided to the WTRU, for example, by an LMF and/or in an assistance information exchange technique. The WTRU may receive a flag that indicates that a TEG is not configured. The WTRU may not receive TEG configuration at the beginning of operation and in this case the WTRU may assume a default time error or no time error.

A WTRU may be configured to determine which resource(s) to use for performing positioning measurement reporting. In examples, the WTRU may be configured to perform TEG-based positioning measurement reporting and may use multiple TEGs (e.g., multiple beams, panels, or antenna ports) to measure DL-PRS. The WTRU may determine to perform positioning measurement reporting (e.g., RSTD, RSRP, etc.) of the resources associated with a TEG (e.g., with one TEG only). This may help the network (e.g., an LMF) cancel out one or more TEGs since the TEG associated with one or more resource(s) (e.g., each resource) may be similar.

A WTRU may be configured to determine the validity of TEG information. In examples, the WTRU may be provided with TEG information by the network. The WTRU may receive an indication (e.g., from the network) about the validity of the TEG information. The WTRU may perform one or more of the following, for example, based on the expiry of the validity of the TEG information. The WTRU may request new TEG information. The WTRU may discard the old TEG information from positioning calculation and/or reporting.

A WTRU may indicate the validity of TEG information to the network. The indication may be provided in TEG reporting. The WTRU may trigger the TEG reporting, for example, based on the expiration of a previous TEG report.

A WTRU may be configured to determine whether to include TEG information in positioning measurement reporting. The WTRU may determine whether to include TEG information in the positioning measurement reporting based one or more of the following. The WTRU may determine whether to include TEG information in the positioning measurement reporting based on the number of TEGs the WTRU uses for DL_PRS reception and/or UL-PRS transmission. For example, the WTRU may report TEG information in the positioning measurement reporting if the WTRU uses at least two TEGs for DL-PRS transmission and/or UL-PRS transmission. The WTRU may determine whether to include TEG information in the positioning measurement reporting based on the TEG(s) the WTRU uses in a previous reporting operation. For example, the WTRU may not provide the TEG information in the positioning measurement reporting if the WTRU uses the same TEG as in a previous reporting operation. The WTRU may provide the TEG information in the positioning measurement reporting, for example, if the WTRU does not use the same TEG as in a previous reporting operation.

A WTRU may be configured to provide TEG information to the network. For example, in a WTRU-based positioning method, the WTRU may provide location information and/or information regarding the association of a TEG and a PRS resource ID. The WTRU may provide TEG information based on one or more of the following triggers: an error variation associated with WTRU position being greater than a threshold (e.g., configurable by the network such as an LMF) or a variation in a positioning measurement being greater than a threshold (e.g., configurable by the network such as an LMF). This may allow the WTRU to indicate to the network (e.g., an LMF) that the received data may include a timing error at the WTRU side. The WTRU may indicate to the network (e.g., an LMF) information regarding an association between an Rx TEG and a PRS resource ID.

A WTRU may be configured to report TEG information that is applicable to multiple positioning methods. The WTRU may determine whether a TEG is applicable for multiple positioning methods and may indicate to the network whether the TEG is applicable to one or more other TEGs used in different positioning methods. The WTRU may report an Rx TEG that is associated with a PRS resource used in more than one positioning method. In examples, the Rx TEG may be associated with measurements (e.g., RSTD, Rx−Tx time difference, etc.) used with the PRS resource and the WTRU may indicate to the network that the same Rx TEG may be used for TDOA or Multi-RTT that requires RSTD or Rx−Tx time difference, respectively. For example, for a Tx TEG, e.g., which may be used for UL-PRS transmission, used for UL TDOA and Multi-RTT, the WTRU may indicate to the network that the same Tx TEG may be applied to both multi-RTT and UL TDOA.

A WTRU may report TEG information to the network (e.g., to an LMF), for example, in a measurement report. The WTRU may report the information in association with one or more positioning methods (e.g., a DL-based positioning method). The WTRU may report one or more of the following: the TEG associated with a PRS resource (e.g., each PRS resource such as a DL-PRS resource, a UL-PRS resource, etc.), or the combined TEG of the resources involved in the measurement of a positioning parameter. In examples (e.g., for a DL-based positioning method), the WTRU may report the TEG information in association with RSTD reporting. In examples, the WTRU may use at least two DL-PRS resources to measure RSTD. In examples, the WTRU may report which TEG is used for a DL-PRS reception (e.g., each DL-PRS reception) if the WTRU uses multiple TEGs to receive the DL-PRS resource(s) involved in RSTD measurement. In examples (e.g., if the WTRU uses one TEG to receive two DL-PRS), the WTRU may report the TEG associated with both DL-PRS resources.

A WTRU may determine to use the same TEG for reception, for example, if the TEG is used to measure one positioning parameter for reporting (e.g., RSTD). In examples, the WTRU may be indicated (e.g., by the network) to use the same TEG for DL-PRS reception and/or UL-PRS transmission. In examples, the WTRU may use the same TEG for DL-PRS reception in two or more DL-PRS resources for RSTD measurement. In examples, the WTRU may use the same beam, antenna port, and/or panel for DL-PRS reception of the DL-PRS resources involved in RSTD measurement. The WTRU may report the TEG associated with the two or more DL-PRS resources to the network.

A WTRU may provide TEG information associated with a measurement used in a UL and DL-based positioning method (e.g., WTRU Rx−Tx time difference measurement). The WTRU may provide combined TEG (e.g., Rx−Tx TEG) associated with a pair of DL-PRS reception and UL-PRS transmission. The combined TEG (e.g., Rx−Tx TEG) may be determined as a function of Tx TEG and/or Rx TEG. The WTRU may include an SRSp resource ID (e.g., an SRSp resource ID used to determine the Tx timing of a WTRU Rx−Tx time difference measurement) if the WTRU reports a WTRU Rx−Tx time difference measurement to a network. The WTRU may indicate in the measurement report (e.g., or in a separate indication or report sent to the network such as an LMF or a gNB) the Tx TEG ID associated with the SRSp resource that is used to determine the Tx timing of the WTRU Rx−Tx time difference measurement.

A WTRU may determine which TEG information to provide based on the capabilities of the WTRU. For example, the WTRU may have one or more of the following capabilities: (1) the capability to associate DL PRS resource(s) or Rx reception timing with Rx TEG, (2) the capability to associate UL positioning reference signal (e.g., SRSp) resource(s) or Tx transmission timing with Tx TEG, the ability to associate DL PRS resource(s) or Rx reception timing with Rx TEG and to associate UL positioning reference signal resource(s) or Tx transmission timing with Tx TEG, or (4) the capability to associate UL positioning reference signal resource(s) and/or DL PRS resource(s) with Rx/Tx TEG or to associate Tx transmission timing and/or Rx reception timing with Rx/Tx TEG. The WTRU may be configured (e.g., preconfigured) to report TEG information associated with an Rx−Tx timing difference. The WTRU may be configured (e.g., preconfigured) with an order for reporting TEG information based on the WTRU's capabilities. For example, the WTRU may be configured (e.g., preconfigured) to report the information described under (4), (3), (2), or (1) above in a certain order based on the WTRU's capabilities. For example, the WTRU may determine to report the information described under (4) if the WTRU is capable of doing so. Otherwise (e.g., if the WTRU is not capable of reporting (4)), the WTRU may report the information described under (3). If the WTRU is not capable of reporting (3) or (4), the WTRU may report the information described under (1) or (2) if the WTRU is capable of doing so. If the WTRU is not capable of reporting any of the TEG information described herein, the WTRU may indicate (e.g., to a network) that it is not capable of reporting TEG information associated with a Rx−Tx timing difference.

A WTRU may determine to report multiple pieces of TEG information associated with a Rx−Tx timing difference. In examples, the WTRU may report information described under (4) and (3) above. The WTRU may report information described under (4) and (1) (or (4) and (2)) above. The WTRU may determine which TEG information to report based on the QoS requirements of a positioning service. The QoS requirements may include, for example, positioning accuracy requirements, the periodicity of a measurement report, and/or the latency of a positioning measurement requirement.

Positioning in wireless systems may be implemented, for example, in the behavior of a WTRU during base station (e.g., gNB) scanning of a channel. A WTRU may be configured (e.g., by a higher layer, for example, higher layer signaling) to report line of sight (LOS). A WTRU may report to the network timing information of the configured downlink (DL) reference signal (RS) for positioning, for example, which may correspond to the largest reference signal received power (RSRP), e.g., among multiple configured positioning reference signal (PRS) beams. LOS reporting may occur, for example, if multi-beam is configured. The network may perform (e.g., conduct) beam sweeping, for example, to find LOS and NLOS.

A WTRU may make a recommendation to associate a path with channel and/or beam information. A WTRU may send a measurement report to the network. The measurement report may include the association of an additional path identification (ID) for a measured multipath (e.g., measured multipath transmission) with at least one of a channel state information reference signal (CSI-RS), a PRS, or sounding reference signal (SRS) beam(s). An associated RS beam may be different from the RS beam the WTRU received, for example, that led to discovery of multipaths. A WTRU-based recommendation of multipath mitigation may consider different beamwidth and/or different granularity of transmission periods/offsets for a UL RS and a DL RS.

There may be DL and UL coordination. A DL and UL positioning method may be configured by the network. A WTRU may transmit multiple configured SRS beams for positioning. The WTRU may (e.g., be configured to) expect and receive a dynamic configuration of an SRS spatial relationship relating SRS for positioning (SRSp) and PRS and/or may receive an indication of which direction the transmitted SRS was used (e.g., DL-UL coordination, no reporting, and/or beam sweeping).

Assisting information for positioning correction may be generated (e.g., at a function, for example, outside of an LMF). A WTRU may obtain assisting information, for example, in an on-demand basis and/or a WTRU may be configured (e.g., by the server) to receive the standalone assisting information. Assisting information for correction may be delivered by a WTRU to the function or delivered to the WTRU from the function (e.g., for WTRU-based positioning). In examples, assisting information may include multipath channel parameters (e.g., a relative power offset, a delay profile, etc.).

A WTRU may send a panel ID to the network, for example, to assist the network with determining an orientation angle of the WTRU. A WTRU may receive assistance information (e.g., periodically) including a timing offset that the WTRU may apply to timing related measurements.

A WTRU may use a first positioning method (e.g., based on multiple round trip time (multi-RTT) with a single SRSp resource to report reception-transmission (Rx−Tx) time difference). The WTRU may switch (e.g., switch autonomously) to a second position method (e.g., based on multi-RTT with N SRSp resources, including a reference SRSp resource, to report Rx−Tx time differences), for example, based on a condition (e.g., detection of multiple paths in a fading channel). The WTRU may switch back to the first position method, for example, based on a termination condition being satisfied (e.g., the WTRU no longer observes the multiple paths in the channel).

A WTRU may receive one or more criteria from the network to use single-path based location estimation. The WTRU may determine to use measurements that correspond to the single path to derive the location estimate, for example, if a minimum number of measurements is available. The WTRU may report the location estimate to the network and may indicate (e.g., to the LMF) that single-path measurements are used to derive the location estimate. The WTRU may, e.g., if a condition is not satisfied switch to multipath based derivation of a location estimate. The WTRU may receive one or more criteria from the network related to the multipath based location estimation. The WTRU may determine to compute a location estimate(s) based on the one or more criteria and may report the location estimate to the network (e.g., to the LMF).

A WTRU may observe multiple paths, for example, through RSRP measurements at a resolution and/or granularity, for example, which may be finer than a default resolution and/or default granularity used by the WTRU for RSRP measurements and/or reporting. The default resolution and/or default granularity for RSRP may be, for example, no granularity, which may indicate that the WTRU is to average the RSRP across resource elements (e.g., all resource elements) in the bandwidth allocated to the WTRU. The WTRU may determine a number of Rx beams to be used for Rx beam sweeping. The WTRU may perform Rx beam sweeping using the determined number of Rx beams and may report RSRP (e.g., at a resolution and/or granularity, which may be finer than that normally used for RSRP reporting) per Rx beam for a PRS resource. The WTRU may indicate to the network that beam sweeping is performed (e.g., conducted) and the orientation of the WTRU has not changed.

A WTRU may indicate to the network whether a timing error group (TEG) is applicable to multiple TEG(s) used in different positioning methods or not. A WTRU may determine a first path RSRP based on the time of arrival of a reference signal observed during a first time window and/or an accumulated or averaged RSRP determined over a second time window.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-12. (canceled)

13. A wireless transmit receive unit (WTRU), comprising:
a processor configured to:
receive a positioning reference signal (PRS) transmission via multiple paths;
associate a first path with a first sounding reference signal for positioning (SRSp), wherein the first path is associated with the first SRSp based on one or more of a first path direction or first SRSp spatial relation information associated with the first path direction, wherein the first SRSp spatial relation information is received from a network entity;
associate a second path with a second SRSp, wherein the second path is associated with the second SRSp based on one or more of a second path direction or second SRSp spatial relation information associated with the second path direction, wherein the second SRSp spatial relation information is received from the network entity; send information indicating the associations to the network entity;
transmit a first SRSp via a first SRSp resource and a second SRSp via a second SRSp resource;
determine a first receive to transmit (Rx−Tx) time difference associated with the first path, wherein the first Rx−Tx time difference is a time difference from a time when the PRS transmission is received via the first path to a time when the first SRSp is transmitted;
determine a second Rx−Tx time difference associated with the second path, wherein the second Rx−Tx time difference is a time difference from a time when the PRS transmission is received via the second path to a time when the second SRSp is transmitted; and
send information indicating the first and second Rx−Tx time differences to the network entity.

14. The WTRU of claim 13, wherein the processor is further configured to:
receive, from the network entity, the first SRSp spatial relation information and the second SRSp spatial relation information;
assign a first path identification (ID) to the first path and a second path ID to the second path;
associate the first path ID with a first SRSp ID, wherein the first path ID is associated with the first SRSp ID based on the first path direction and the first SRSp spatial relation information associated with the first path direction; and
associate the second path ID with a second SRSp ID, wherein the second path ID is associated with the second SRSp ID based on the second path direction and the second SRSp spatial relation information associated with the second path direction.

15. The WTRU of claim 14, wherein the information indicating the first and second Rx−Tx time differences further comprises the first path ID associated with the first SRSp ID and the second path ID associated with the second SRSp ID.

16. The WTRU of claim 13, wherein the network entity is a location management function (LMF) or a base station (gNB).

17. The WTRU of claim 13, wherein the processor is further configured to:
receive information indicating, from the network entity, to associate respective paths with respective SRSps.

18. The WTRU of claim 13, wherein the first path is associated with the first SRSp based on the first path direction aligning with the first SRSp spatial relation information associated with the first path direction, and wherein the second path is associated with the second SRSp based on the second path direction aligning with the second SRSp spatial relation information associated with the second path direction.

19. A method, comprising:
receiving a positioning reference signal (PRS) transmission via multiple paths;
associating a first path with a first sounding reference signal for positioning (SRSp), wherein the first path is associated with the first SRSp based on one or more of a first path direction or first SRSp spatial relation information associated with the first path direction, wherein the first SRSp spatial relation information is received from a network entity;
associating a second path with a second SRSp, wherein the second path is associated with the second SRSp based on one or more of a second path direction or second SRSp spatial relation information associated with the second path direction, wherein the second SRSp spatial relation information is received from the network entity;
sending information indicating the associations to the network entity;
transmitting a first SRSp via a first SRSp resource and a second SRSp via a second SRSp resource;
determining a first receive to transmit (Rx−Tx) time difference associated with the first path, wherein the first Rx−Tx time difference is a time difference from a time when the PRS transmission is received via the first path to a time when the first SRSp is transmitted;
determining a second Rx−Tx time difference associated with the second path, wherein the second Rx−Tx time difference is a time difference from a time when the PRS transmission is received via the second path to a time when the second SRSp is transmitted; and
sending information indicating of the first and second Rx−Tx time differences to the network entity.

20. The method of claim 19 further comprising:
receiving, from the network entity, the first SRSp spatial relation information and the second SRSp spatial relation information;
assigning a first path identification (ID) to the first path and a second path ID to the second path;
associating the first path ID with a first SRSp ID, wherein the first path ID is associated with the first SRSp ID based on the first path direction and the first SRSp spatial relation information associated with the first path direction; and
associating the second path ID with a second SRSp ID, wherein the second path ID is associated with the second SRSp ID based on the second path direction and the second SRSp spatial relation information associated with the second path direction.

21. The method of claim 20, wherein the information indicating the first and second Rx−Tx time differences further comprises the first path ID associated with the first SRSp ID and the second path ID associated with the second SRSp ID.

22. The method of claim 19, wherein the network entity is a location management function (LMF) or a base station (gNB).

23. The method of claim 19 further comprising:
receiving information indicating, from the network entity, to associate respective paths with respective SRSps.

24. The method of claim 19, wherein the first path is associated with the first SRSp based on the first path direction aligning with the first SRSp spatial relation information associated with the first path direction, and wherein the second path is associated with the second SRSp based on the second path direction aligning with the second SRSp spatial relation information associated with the second path direction.
